(19) United States
(12) Patent Application Publication
(10) Pub. No.: US 2023/0281662 A1
(43) Pub. Date: Sep. 7, 2023

(54) SERVICE DATA PROCESSING METHOD AND APPARATUS, ELECTRONIC DEVICE, COMPUTER-READABLE STORAGE MEDIUM AND COMPUTER PROGRAM PRODUCT

(71) Applicant: TENCENT TECHNOLOGY (SHENZHEN) COMPANY LIMITED, Shenzhen (CN)

(72) Inventor: Bangpeng LI, Shenzhen (CN)

(21) Appl. No.: 18/316,081

(22) Filed: May 11, 2023

Related U.S. Application Data
(63) Continuation of application No. PCT/CN2022/099533, filed on Jun. 17, 2022.

(30) Foreign Application Priority Data
Aug. 11, 2021 (CN) 202110919651.0

(51) Int. Cl. G06Q 30/0251; G06Q 30/0241

(52) U.S. Cl. CPC G06Q 30/0254; G06Q 30/0277

(57) ABSTRACT

A service data processing method and apparatus, an electronic device, a computer-readable storage medium and a computer program product are provided. The service data processing method includes acquiring a delivery log corresponding to delivered service data, the delivery log comprising service output states and service conversion states of a service object set; establishing unconverted browsing behavior features of a target service object for unconverted service data according to the service output states and service conversion states of the service object set, the delivered service data comprising the unconverted service data, and the service object set comprising the target service object; determining a ranking factor corresponding to the target service object and the unconverted item; and ranking service data to obtain sequenced service data according to the ranking factor, and selecting and delivering target service data from the sequenced service data according to ranking order to the target service object.

### RELATED APPLICATIONS

This application is a continuation of PCT/CN2022/099533, filed on Jun. 17, 2022, which claims the priority to the Chinese Patent Application with Application No. 202110919651.0 filed on Aug. 11, 2021. The entire content of the two applications are hereby incorporated by reference in their entirety.

### FIELD OF THE TECHNOLOGY

This application relates to the field of computer technologies, and in particular to a service data processing method and apparatus, an electronic device, a computer-readable storage medium and a computer program product.

### BACKGROUND OF THE DISCLOSURE

With the rapid development of computer technology, many users release or acquire information through applications on an electronic device. Users who create service data can deliver the service data through applications that deliver the service data on the electronic device.

In general, an application platform will rank all service data before the service data is delivered to a user group, and then delivers the ranked service data to the user group. In order to improve the conversion rate (i.e., the ratio of the number of users who perform conversion behaviors such as place an order and purchase generated by the service data to the number of users who click the service data), all the service data will be repeatedly delivered always in a same order. However, this approach will cause delivery of the service data. As a result, platform's resources (computing resources such as processor threads, communication resources such as bandwidth) are greatly wasted, which not only increases the cost of data processing, but also makes it difficult to improve the delivery accuracy of the service data.

### SUMMARY

Embodiments of this application provide a service data processing method and apparatus, an electronic device, a computer-readable storage medium and a computer program product, which can improve the delivery precision of service data, improve the delivery accuracy of the service data and save resources.

One embodiment provides a service data processing method. The method includes acquiring a delivery log corresponding to N pieces of delivered service data, the delivery log comprising service output states and service conversion states of a service object set for the N pieces of delivered service data, N being a positive integer; the service conversion state comprising an unconverted state, the service output state comprising an outputted state; establishing unconverted browsing behavior features of a target service object for unconverted service data according to the service output states and service conversion states of the service object set for the N pieces of delivered service data, the service output state of the target service object for the unconverted service data being the outputted state and the service conversion state being the unconverted state, the N pieces of delivered service data comprising the unconverted service data, the unconverted service data comprising an unconverted item, and the service object set comprising the target service object; determining a ranking factor corresponding to both the target service object and the unconverted item according to the unconverted browsing behavior features; and ranking service data comprising the unconverted item to obtain sequenced service data according to the ranking factor, and selecting target service data from the sequenced service data according to ranking order and delivering the target service data to the target service object.

One embodiment provides an electronic device, including: a processor and a memory; the storage medium stores a computer program. When the computer program is executed by the processor, the processor performs the method in one embodiment.

One embodiment provides a non-transitory computer-readable storage medium. The computer-readable storage medium stores a computer program. The computer program includes a program instruction. The program instruction, when executed by the processor, performs the method in one embodiment.

In one embodiment, according to real-time feedback data (the service output state, the service conversion state, etc.) of the target service object on the delivered service data, the unconverted service data in the outputted state and unconverted state, corresponding to the target service object is determined. Since the service output state of the target service object to the unconverted service data is the outputted state, it indicates that the target service object is interested in a service item in the unconverted service data. Thus, in the process of working out the ranking factor corresponding to both the target service object and the service item, and then ranking the service data including a same unconverted item according to the ranking factor, and selecting the target service data from the sequenced service data in ranking order and delivering the target service data to the target service object, the potential preference of the target service object can be indicated according to these pieces of unconverted service data (the target service object has a relatively high probability of conversion of the unconverted item in the unconverted service data). The service data including unconverted item is ranked and delivered according to the preference, such that the delivered service data conforms to the preference of the target service object. Therefore, the delivered service data is more accurate, which can save processing resources.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description are only some embodiments of this application, and a person of ordinary skill in the art may also obtain other drawings from these accompanying drawings without creative efforts.

FIG. 1 is a network architecture diagram in an embodiment of this application;

FIGS. 2a to 2c are a schematic diagram of a scenario of determining a ranking factor in an embodiment of this application;

FIG. 3 is a schematic flowchart of a service data processing method in an embodiment of this application;

FIG. 4 is a schematic flowchart of another service data processing method in an embodiment of this application;

FIG. 5 is a schematic diagram of similar service data recommendation processing based on browsing feedback data of a target service object in an embodiment of this application.

FIG. 6 is a system structure diagram in an embodiment of this application;

FIG. 7 is a structural schematic diagram of a service data processing apparatus in an embodiment of this application; and

FIG. 8 is a schematic structural diagram of a computer device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

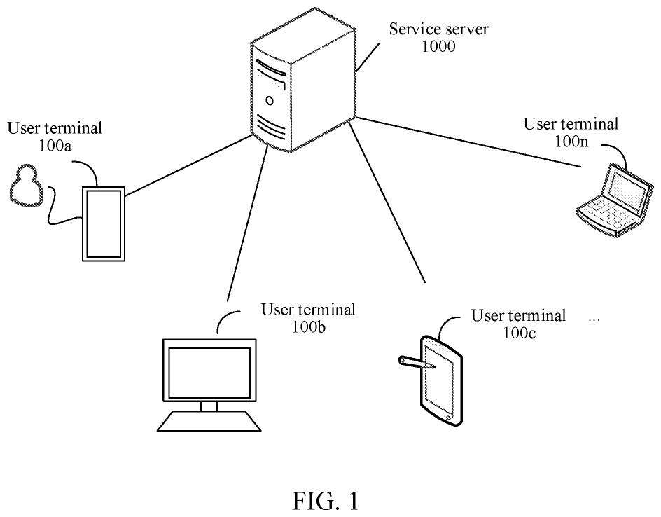

Refer to FIG. 1, FIG. 1 being a network architecture diagram in an embodiment of this application. As shown in FIG. 1, the network architecture may include a service server 1000 and a user terminal cluster. The user terminal cluster may include one or more user terminals. The quantity of the user terminals will not be limited here. As shown in FIG. 1, the multiple user terminal clusters may include a user terminal 100a, a user terminal 100b, a user terminal 100c . . . , and a user terminal 100n. As shown in FIG. 1, the user terminal 100a, the user terminal 100b, the user terminal 100c . . . , and the user terminal 100n may be connected with the service server 1000 via a network, so that each user terminal may perform data interaction with the service server 1000 through the connection via the network.

It can be understood that each terminal device (referred to as the user terminal) shown in FIG. 1 can be installed with a target application. When running in each terminal device, the target application can perform data interaction with the service server 1000 shown in FIG. 1, such that the service server 1000 can receive the service data from each terminal device. The target application may include applications with a function of displaying texts, images, audios, videos and other data information. For example, applications may be applications that support service data delivery, such as multimedia applications (such as video applications), entertainment applications (such as a game application) and social applications. It is to be understood that the service data in one embodiment may be media data (such as advertisement data). It is illustrated below using the service data as the advertisement data as an example.

The service server 1000 in one embodiment can acquire, from a service creation object (the service creation object may refer to the application account of a user who creates the advertisement data in the application. The service creation object may also refer to a terminal device corresponding to the user who creates the advertisement data; where the user who creates the advertisement data may also be referred to as a service creation user or advertiser), the advertisement data-to-be-delivered created by a service creation user, according to these applications. The service server 1000 in one embodiment can also acquire, from an account or terminal device corresponding to a service delivery platform (for example, when the service data is the advertisement data, the service delivery platform is also an advertisement delivery platform), delivery logs (advertisement logs, i.e., related delivered data of the advertisement data) of these pieces of advertisement data-to-be-delivered according to these applications. Each piece of delivered advertisement data may correspond to one delivery log (or one delivery log may include the related delivered data of all the advertisement data-to-be-delivered therein). The delivery log may include the exposure amount (the quantity of object identifiers of service objects (i.e., application accounts of users of the advertisement data-to-be-delivered in the application) that click and play the advertisement data after the advertisement data is delivered to a user group) of each piece of advertisement data-to-be-delivered and a real-time conversion quantity (the quantity of object identifiers of service objects that click and convert the advertisement data after the advertisement data is delivered to the user group).

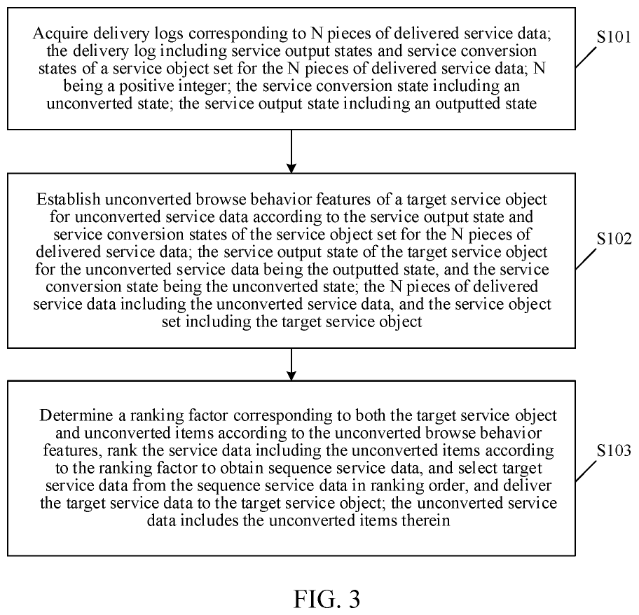

It is to be understood that the advertisement data-to-be-delivered may be referred to as the delivered service data (delivered advertisement data). It is illustrated below with the delivered service data being referred to as the delivered advertisement data. After the service server 1000 acquires the advertisement log of the delivered advertisement data, the delivered advertisement data that each service object clicks and plays in a service object set-to-be-delivered can also be acquired, and the delivered advertisement data for each service object to generate conversion behaviors (such as bookmark, place an order and purchase, store visit, etc.) can also be determined. When a certain service object clicks and plays a certain piece of delivered service data, but a conversion behavior is not generated, the service object may be referred to as the target service object, and the delivered service data may be referred to as unconverted advertisement data (also referred to as unconverted service data). Subsequently, the service server 1000 may establish unconverted browsing behavior features of the target service object for the unconverted advertisement data, and determine a ranking factor corresponding to both the target service object and an unconverted item (i.e., items included in the unconverted advertisement data, which may be items, such as videos, electronic products; or they can be virtual items, such as game props, the advertisement data may each include different items-to-be-promoted, and the service object can perform the conversion such as place an order and purchase the item through the advertisement data) according to the unconverted browsing behavior features. Subsequently, the service data (advertisement data) including a same unconverted item can be ranked based on this ranking factor, and then target service data (target advertisement data) can be selected from these pieces of ranked service data and delivered to the target service object in order. For embodiments of establishing the unconverted browsing behavior features of the target service object for the unconverted advertisement data, and determining the ranking factor corresponding to both the target service object and the unconverted item according to the unconverted browsing behavior features, and delivering the target service data and the service data to the target service object, refer to the corresponding description in FIG. 3 below.

It is to be understood that through real-time feedback data of the service object on the delivered advertisement data, the delivered advertisement data that has been clicked and watched (i.e., click and play) by a certain service object can be determined. Thus, the preferences of the service object for the items can be determined. Thus, the advertisement data including the same item can be delivered for the service object according to the preferences of the service object for the items. Since these pieces of advertisement data conforms to the preferences of the service object, after the advertisement data including the same item are delivered to the service object, the service object is likely to click and watch the delivered advertisement data and generate the conversion behavior, which can improve the conversion rate of the advertisement data.

One embodiment can select one terminal device from multiple terminal devices as a target terminal device (the target terminal device may be a terminal device corresponding to the service creation user, or a terminal device corresponding to the service delivery platform). The terminal device may include: smart terminals that carry multimedia data processing functions (such as a video data playback function and a music data playback function), such as a smart phone, a tablet computer, a notebook computer, a desktop computer, a smart TV, a smart speaker, a desktop computer, a smart watch and an on-board device, which are not limited to this. For example, one embodiment can take the user terminal 100a shown in FIG. 1 as the target terminal device. The target terminal device can integrate the above-mentioned target application therein. At this time, the target terminal device can perform data interaction with the service server 1000 through the target application.

It can be understood that the service data processing method in one embodiment can be performed by a computer device (referred to as an electronic device). The computer device includes, but is not limited to, the terminal device or service server. The service server may be an independent physical server, or a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, a content delivery network (CDN), and big data and artificial intelligence platforms.

The terminal device and the service server can be connected directly or indirectly via wired or wireless communications, which will not be limited in one embodiment here.

It can be understood that the above-mentioned computer device (such as the above-mentioned service server 1000, the user terminal 100a, the user terminal 100b, etc.) may be a node in a distributed system, where the distributed system may be a blockchain system, and the blockchain system may be a distributed system formed by connecting multiple nodes via network communications. The nodes can form a peer to peer (P2P) network, and a P2P protocol corresponding to the peer to peer network is an application layer protocol running over a transmission control protocol (TCP). In the distributed system, any form of computer device, such as the electronic devices such as the service server and the terminal device, can become a node in the blockchain system by joining the peer to peer network. For ease of understanding, the concept of blockchain is illustrated below.

The blockchain is a new application mode using distributed data storage, peer to peer transmission, a consensus mechanism, an encryption algorithm and other computer technologies, which is used for arranging data in chronological order and encrypting the arranged data into an account book, such that the arranged data cannot be tampered and forged, and at the same time, the data can be verified, stored and updated. When the computer device is a blockchain node, due to tamper-proof and anti-forgery characteristics of the blockchain, the data in one embodiment (such as the delivery related data for the delivered service data, etc.) can be made to have authenticity and security, and thus, results obtained after related service data processing based on these data are more reliable than service data processing results obtained without combining with the blockchain.

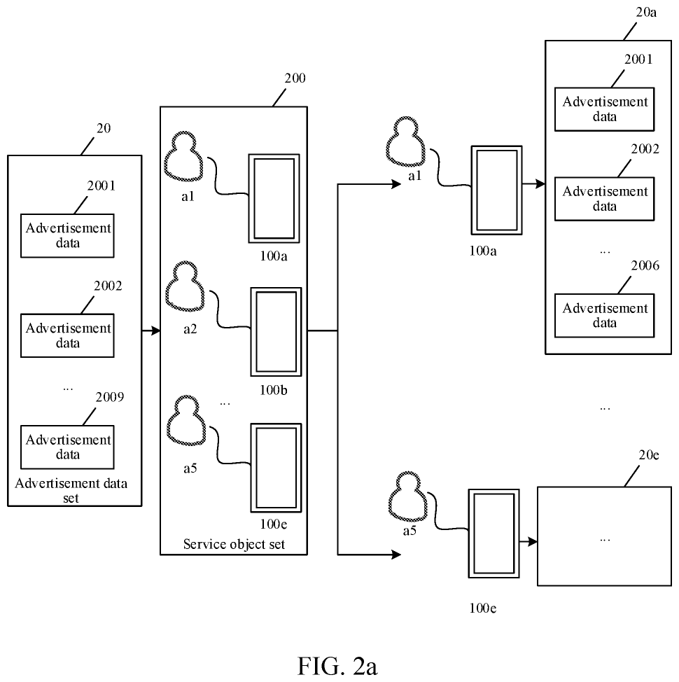

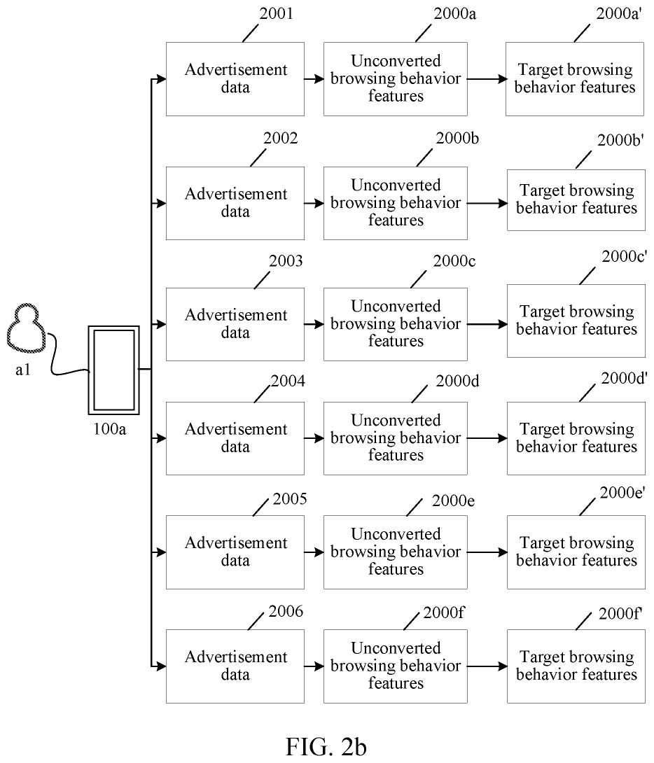

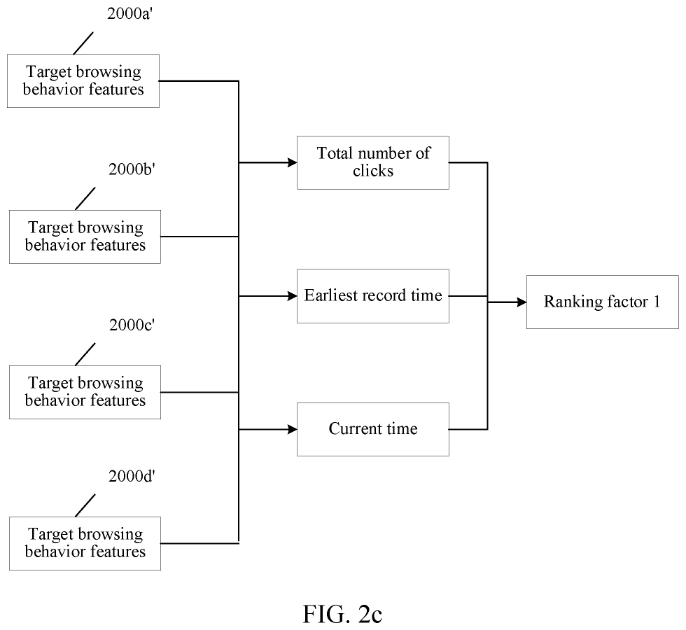

For ease of understanding, refer to FIGS. 2a to 2c, FIGS. 2a to 2c being a schematic diagram of a scenario of determining a ranking factor in an embodiment of this application. The user terminal 100a to the user terminal 100e as shown in FIGS. 2a to 2b belongs to respective corresponding terminal devices in FIG. 1 above.

The scenario shown in FIGS. 2a to 2c is a delivery scenario that takes delivering an advertisement data set 20 to a service object set 200 as an example, where the advertisement data set 20 may include 9 pieces of advertisement data therein in total, including advertisement data 2001, advertisement data 2002, advertisement data 2003, . . . , and advertisement data 2009; where the advertisement data 2001, the advertisement data 2002, the advertisement data 2003, the advertisement data 2004 and the advertisement data 2008 each include a service item “liquid foundation” therein; the advertisement data 2005 and the advertisement data 2006 each include a service item “pure milk” therein; and the advertisement data 2007 and the advertisement data 2009 each include a service item “biscuits” therein. Since after the advertisement data set 20 is delivered to the service object set 200, each piece of advertisement data in the advertisement data set is the delivered advertisement data, each piece of advertisement data is referred to as the delivered advertisement data.

As shown in FIG. 2a, the service object set 200 may include a service object a1, a service object a2, a service object a3, a service object a4 and a service object a5 therein, and a click behavior (the click behavior is that the service object clicks and plays the advertisement data) and the conversion behavior (the conversion behavior is that a place-an-order or purchase behavior (i.e., place an order for or purchase the service items promoted in the service data) is generated after the service object clicks and plays a certain piece of service data) of each service object for these pieces of delivered advertisement data can be acquired. Thus, delivered advertisement data that both the click behavior and an unconverted behavior are present can be then determined for each service object. After the click behavior and conversion behavior of each service object for the delivered advertisement data are acquired, a data group between a service object and a piece of advertisement data can be established according to data such as the object identifier (used for representing the service object, the object identifier may be an object name, an object identity document (ID), etc.) of the service object, an advertisement identifier (used for representing the advertisement data, the advertisement identifier may be an advertisement name, an advertisement ID, etc.) of the delivered advertisement data, whether there is the click behavior or not, whether there is the conversion behavior or not and the record time that the click behavior is generated.

Here, taking the service object a1 and the delivered advertisement data 2001 as examples, if the service object a1 clicks and plays the delivered advertisement data 2001, but the conversion behavior is not generated to the delivered advertisement data, a data group for the service object a1 and the delivered advertisement data 2001 may be [a1, 2001, 1, 0, 14:00], where the third value 1 in the data group can be used for representing that the service object a1 generates the click behavior to the delivered advertisement data 2001, the fourth value 0 in the data group can be used for representing that the service object a1 does not generate the conversion behavior to the delivered advertisement data 2001, the time information 14:00 in the data group may be 14:00 on Aug. 7, 2021. The time information can be used for representing the time that the service object a1 generates the click behavior to the delivered advertisement data 2001, that is, the service object a1 clicked and played the delivered advertisement data 2001 at 14:00 on Aug. 7, 2021. It is to be understood that whether the service object a1 has the click behavior for the delivered advertisement data can be understood as a service output state of the service object a1 for the delivered advertisement data. For example, if the service object a1 has the click behavior for the delivered advertisement data 2001, that is, the service object a1 clicks and plays the delivered advertisement data 2001, the service output state of the service object a1 for the delivered advertisement data 2001 is an outputted state. If the service object a1 does not have the click behavior for the delivered advertisement data 2001, that is, the service object does not click and play the delivered advertisement data 2001, the service output state of the service object a1 for the delivered advertisement data 2001 is a non-outputted state. Whether the service object a1 has the conversion behavior for the delivered advertisement data can be understood as a service conversion state of the service object for the delivered advertisement data. For example, if the service object a1 has the conversion behavior to the delivered advertisement data, the service conversion state of the service object a1 for the delivered advertisement data is a converted state. If the service object a1 does not have the conversion behavior to the delivered advertisement data, the service conversion state of the service object a1 for the delivered advertisement data is an unconverted state.

It is to be understood that the above-mentioned data group [a1, 2001, 1, 0, 14:00] for the service object a1 and the delivered advertisement data 2001 can be determined as browsing behavior features of the service object a1 for the delivered advertisement data 2001. Similarly, a data group of each service object for all the delivered advertisement data can be constructed, that is, the browsing behavior features of each service object for all the delivered advertisement data can be constructed. After the browsing behavior features of each service object for all the delivered advertisement data are obtained, since each browsing behavior feature includes the object identifier of each service object, the advertisement identifier of the delivered advertisement data, whether there is the click behavior or not, whether there is the conversion behavior or not, and the record time that the click behavior occurs (if no click behavior occurs, the record time may be a specified value, such as a blank value) therein, then through all the browsing behavior features, the delivered advertisement data that both the click behavior and the unconverted behavior are present can be determined for each service object. These pieces of delivered advertisement data that the click behavior is generated but the conversion behavior is not generated for the service object may be referred to as the unconverted service data (referred to as the unconverted advertisement data in FIGS. 2a to 2c) for the service object.

The unconverted advertisement data corresponding to the service object may be service object a1. Through the browsing behavior features of the object identifier of the service object a1, it can be determined that the service object a1 clicks and plays the delivered advertisement data 2001, the delivered advertisement data 2002, the delivered advertisement data 2003, the delivered advertisement data 2004, the delivered advertisement data 2005 and the delivered advertisement data 2006. At the same time, for the delivered advertisement data 2001, the delivered advertisement data 2002, the delivered advertisement data 2003, the delivered advertisement data 2004, the delivered advertisement data 2005 and the delivered advertisement data 2006, the service object a1 does not generate the conversion behavior such as place an order or purchase, and therefore, for the service object a1, it can be determined that a delivered advertisement data set 20a (including the delivered advertisement data 2001, the delivered advertisement data 2002, the delivered advertisement data 2003, the delivered advertisement data 2004, the delivered advertisement data 2005 and the delivered advertisement data 2006) is unconverted advertisement data corresponding to the service object a1.

Similarly, unconverted advertisement data (e.g., a delivered advertisement data set 20b) for the service object a2, unconverted advertisement data (e.g., a delivered advertisement data set 20c) for the service object a3, unconverted advertisement data (e.g., a delivered advertisement data set 20d) for the service object a4 and unconverted advertisement data (e.g., a delivered advertisement data set 20e) for the service object a5 can be determined from the advertisement data set 20. Further, the browsing behavior features of each target service object for their respective unconverted advertisement data can be determined by taking each service object as the target service object. For ease of understanding, the browsing behavior feature of one target service object for one unconverted advertisement data can be referred to as the unconverted browsing behavior feature. In FIG. 2a, the service object a3 and the service object a4, as well as the delivered advertisement data set 20b, the delivered advertisement data set 20c and the delivered advertisement data set 20d, are shown in the form of ellipsis ( . . . ).

As shown in FIG. 2b, the unconverted browsing behavior features of the target service object for the unconverted advertisement data are illustrated with taking the target service object as the service object a1 (hereinafter referred to as the target service object a1) as an example (since the delivered advertisement data set 20a is the unconverted advertisement data corresponding to the service object a1, each piece of delivered advertisement data in the delivered advertisement data set 20a will be hereafter referred to as the unconverted advertisement data). The browsing behavior feature of the target service object a1 for the unconverted advertisement data 2001 is the data group [a1, 2001, 1, 0, 14:00]. The data group [a1, 2001, 1, 0, 14:00] can be used as an unconverted browsing behavior feature 2000a of the target service object a1 for the unconverted advertisement data 2001. Similarly, the browsing behavior feature of the target service object a1 for the unconverted advertisement data 2002 is a data group [a1, 2002, 1, 0, 14:10], the browsing behavior features of the target service object a1 for the unconverted advertisement data 2003 is a data group [a1, 2003, 1, 0, 14:20], the browsing behavior feature of the target service object a1 for the unconverted advertisement data 2004 is a data group [a1, 2004, 1, 0, 14:30], the browsing behavior feature of the target service object a1 for the unconverted advertisement data 2005 is a data group [a1, 2005, 1, 0, 14:40], and the browsing behavior feature of the target service object a1 for the unconverted advertisement data 2006 is a data group [a1, 2006, 1, 0, 14:50] (the time information in the above data groups may be Aug. 7, 2021). From this, it can be determined that the data group [a1, 2002, 1, 0, 14:10] can be used as an unconverted browsing behavior feature 2000b of the target service object a1 for the unconverted advertisement data 2002, the data group [a1, 2003, 1, 0, 14:10] can be used as an unconverted browsing behavior feature 2000c for the unconverted advertisement data 2003, the data group [a1, 2004, 1, 0, 14:10] can be used as unconverted browsing behavior feature 2000d for the unconverted advertisement data 2004, the data group [a1, 2005, 1, 0, 14:10] can be used as unconverted browsing behavior feature 2000e for the unconverted advertisement data 2005, and the data group [a1, 2006, 1, 0, 14:10] can be used as an unconverted browsing behavior feature 2000f for the unconverted advertisement data 2006.

In one embodiment, advertisement recognition is performed on these pieces of unconverted advertisement data corresponding to the target service object a1 to determine the service items included in these pieces of unconverted advertisement data (since the advertisement data is an unconverted advertisement, for the sake of understanding, the service item included in the unconverted advertisement data will be referred to as the unconverted item), then an advertisement identifier of the unconverted advertisement data included in each unconverted browsing behavior feature is replaced with an item identifier of the service item included in the unconverted advertisement data. Thus, a target browsing behavior feature of the target service object a1 for each service item can be obtained.

The target browsing behavior feature may be the unconverted advertisement data. In one embodiment, the advertisement data 2001, the advertisement data 2002, the advertisement data 2003, the advertisement data 2004 and the advertisement data 2008 each include the service item “liquid foundation” therein, and the advertisement data 2005, the advertisement data 2006, the advertisement data 2007 and the advertisement data 2008 each include the service item “pure milk” therein. Thus, it can be determined by the advertisement recognition that the unconverted advertisement data 2001 includes the unconverted item “liquid foundation” therein. If the item identifier of the “liquid foundation” is FDY001, then for the unconverted browsing behavior feature [a1, 2001, 1, 0, 14:00] of the target service object a1 for the unconverted advertisement data 2001, the advertisement identifier 2001 in the data group [a1, 2001, 1, 0, 14:00] can be replaced with the item identifier FDY001 of the “liquid foundation”. Thus, it can be obtained that a target browsing behavior feature 2000a′ of the target service object a1 for the unconverted item “liquid foundation” is [a1, FDY001, 1, 0, 14:00]. Similarly, a target browsing behavior feature 2000b′ (i.e., a data group [a1, FDY001, 1, 0, 14:10], corresponding to the unconverted browsing behavior feature 2000b) of the target service object a1 for the unconverted item “liquid foundation”, a target browsing behavior feature 2000c′ (i.e., a data group [a1, FDY001, 1, 0, 14:20], corresponding to the unconverted browsing behavior feature 2000c) for the unconverted item “liquid foundation”, a target browsing behavior feature 2000d′ (i.e., a data group [a1, FDY001, 1, 0, 14:30], corresponding to the unconverted browsing behavior feature 2000d) for the unconverted item “liquid foundation”, a target browsing behavior feature 2000e′ (i.e. [a1, CN001, 1, 0, 14:40], corresponding to the unconverted browsing behavior feature 2000e, CN001 being the item identifier of the “pure milk”) for the unconverted item “pure milk”, a target browsing behavior feature 2000f′ (i.e., [a1, CN001, 1, 0, 14:50], corresponding to the unconverted browsing behavior feature 2000f) for the unconverted item “pure milk” can be determined.

In one embodiment, the target browsing behavior features (i.e., the target browsing behavior features with a same item identifier) belonging to a same service item can be acquired from the target browsing behavior features of the target service object a1 for each service item. According to the target browsing behavior features belonging to the same service item, the ranking factor (the ranking factor can be used for representing the degree of interest of the target service object in a certain service item. That is, the ranking factor corresponding to both the target service object and the service item can be understood as the degree of interest of the target service object in the service item. In one embodiment, the ranking factor of a target service object and a certain service item is associated with the number of clicks of the target service object on the service item, and the number of clicks can indicate the degree of interest of the target service object in the service item. The more the number of clicks of the target service object on a certain service item, the higher the degree of interest of the target service object in the service item, then the larger the ranking factor corresponding to both the target service object and the service item) corresponding to both the target service object a1 and the service item can be determined.

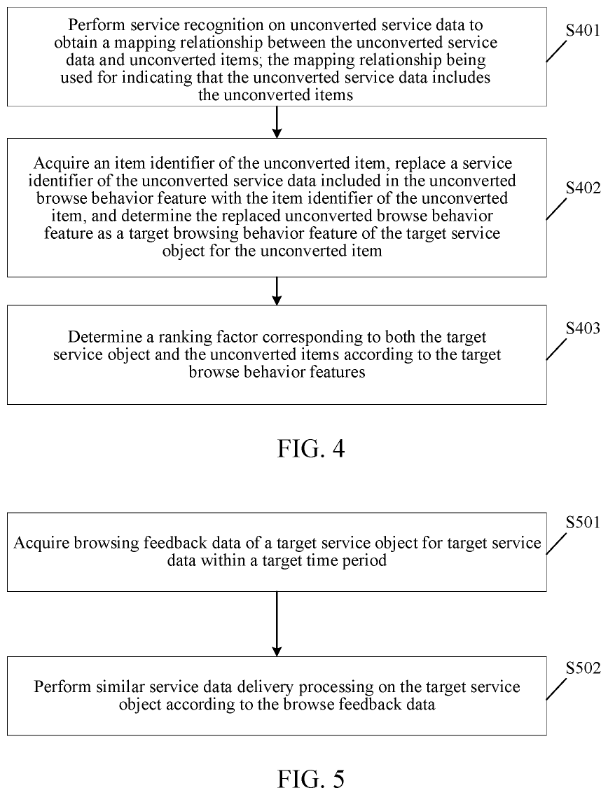

The process of determining the ranking factor will be illustrated below. As shown in 2c, taking the unconverted item “liquid foundation” as an example, since the data group [a1, 2001, 1, 0, 14:00], the data group [a1, 2002, 1, 0, 14:10], the data group [a1, 2003, 1, 0, 14:20], and the data group [a1, 2004, 1, 0, 14:30] are all the browsing behavior features of the target service object a1 for the unconverted item “liquid foundation”, the total number of clicks of target service object a1 for the unconverted item “liquid foundation” can be statistically determined according to these browsing behavior features (one browsing behavior feature corresponds to one click behavior, then the total number of clicks may be the total quantity of this browsing behavior feature, i.e., 4). Subsequently, earliest record time (i.e., the earliest time when the target service object a1 that generates the clicks behavior for the unconverted item “liquid foundation”, also referred to as the earliest click time) can be acquired from these browsing behavior features, and the earliest record time is 14:00 (i.e., 14:00 on Aug. 7, 2021). At the same time, the current time (the current moment can be understood as a moment when these pieces of information are acquired) can also be acquired. Finally, the ranking factor 1 corresponding to both the target service object a1 and the unconverted item “liquid foundation” can be determined according to the total number of clicks, the earliest record time and the current time. That is, the ranking factor 1 corresponding to both the target service object a1 and the unconverted item “liquid foundation” is associated with the number of clicks of the target service object a1 on the unconverted item “liquid foundation”. For the specific implementation of determining the ranking factor according to the total number of clicks, the earliest record time and the current time, refer to corresponding descriptions in FIGS. 3 to 4 below.

Similarly, a ranking factor 2 corresponding to both the target service object a1 and the unconverted item “pure milk” can also be determined. In one embodiment, the delivered advertisement data (i.e., the advertisement data 2001, the advertisement data 2002, the advertisement data 2003, the advertisement data 2008, the advertisement data 2005 and the advertisement data 2006. Since these pieces of delivered advertisement data will be ranked subsequently, for ease of distinguishing and understanding, these pieces of delivered advertisement data including the unconverted item “liquid foundation” and including the unconverted item “pure milk” can also be referred to as delivered advertisement data-to-be-ranked) including the unconverted item “liquid foundation” and including the unconverted item “pure milk” can be acquired from the advertisement data set 20. At the same time, advertisement data-to-be-delivered including the unconverted item “liquid foundation” and including the unconverted item “pure milk” can also be acquired from a candidate advertisement data set that has not been delivered to the service object set 200. The candidate advertisement data set may refer to a set composed of advertisement data waiting to be delivered. These pieces of advertisement data-to-be-delivered including the unconverted item “liquid foundation” and including the unconverted item “pure milk”, as well as the delivered advertisement data (i.e. the delivered advertisement data-to-be-ranked) including the unconverted item “liquid foundation” and including the unconverted item “pure milk”, can be determined as advertisement data including the unconverted item “liquid foundation” and including the unconverted item “pure milk”.

In one embodiment, the delivered advertisement data that the target service object a1 does not generate the click behavior for the advertisement data set 20 can also be acquired (since the service object a1 does not click and play these pieces of advertisement data, the target service object a1 does not play and watch these pieces of advertisement data, and these pieces of advertisement data may be referred to as unplayed advertisement data, non-clicked advertisement data, or non-outputted advertisement in one embodiment). If the unplayed advertisement data is the advertisement data 2009, the above-mentioned advertisement data including the unconverted item “liquid foundation” and including the unconverted item “pure milk”, as well as the unplayed advertisement data 2009, can be ranked according to the ranking factor 1 and the ranking factor 2 to obtain sequence advertisement data, and the target advertisement data is selected by ranked results and is delivered to the target service object a1. For a ranking mode and a mode of selecting the target advertisement data, refer to corresponding descriptions in FIG. 3 below.

It is to be understood that in one embodiment, the unconverted advertisement data that the target service object a1 generates the click behavior but does not generate the conversion behavior can be determined by acquiring real-time feedback information, such as the click behavior, the conversion behavior and the time when the click behavior occurs, of the target service object a1 for each piece of delivered advertisement data. By establishing the unconverted browsing behavior features of target service object a1 for all unconverted service advertisement data, the ranking factor of the target service object a1 for the unconverted item can be then determined based on the unconverted browsing behavior features. Since the target service object a1 clicks these pieces of unconverted advertisement data, it can indicate that the target service object a1 is interested in the unconverted items corresponding to these pieces of advertisement data. Therefore, in one embodiment, the ranking factor of the unconverted item can be determined based on the unconverted browsing behavior features, and then the advertisement data including the unconverted item and the non-clicked advertisement data are ranked based on the ranking factor. Due to the existence of the ranking factor, when ranking from big to small, the possibility that the advertisement data including the unconverted item is arranged before the non-clicked advertisement data is increased. In a process of re-delivering the advertisement data, part of the advertisement data ranking top will be generally selected and delivered, that is, the advertisement data including the unconverted item will be preferably delivered to the target service object a1. Since the target service object a1 is interested in, then compared with the probability that the target service object a1 will generate the conversion behavior for other advertisement data not including the unconverted item, the probability that the target service object a1 generates the conversion behavior for the advertisement data including the unconverted item is higher, which can improve the conversion rate. In one embodiment, accurate delivery is performed according to the preference of each service object, so that the conversion rate can be improved.

Various parameters such as the advertisement identifier (such as 2001), the object identifier (such as a1), the item identifier (such as FDY001), whether the value (1 or 0) of the click behavior is present or not, whether the value (1 or 0) of the conversion behavior is present or not, a record timestamp (such as 14:00), and the browsing behavior features (such as the data group [a1, 2002, 1, 0, 14:10]) are all examples for ease of understanding, and do not have practical reference significance.

Refer to FIG. 3, FIG. 3 being a schematic flowchart of a service data processing method in an embodiment of this application, where the service data processing method may be performed by the electronic device such as the computer device. It is illustrated here with taking a case that the service data processing method is performed by the computer device as an example. In addition, the computer device here may refer to the service server (such as the service server in FIG. 1 above) or the terminal device (such as any terminal device in a terminal device cluster in FIG. 1 above). As shown in FIG. 3, the flow of the service data processing method may include at least steps S101 to S103. Each step is described below.
S101: Acquire delivery logs corresponding to N pieces of delivered service data; the delivery log including service output states and service conversion states of a service object set for the N pieces of delivered service data; N being a positive integer; the service conversion state including an unconverted state; and the service output state including an outputted state;

In one embodiment, the service data may refer to the media data (such as the advertisement data). The delivery may refer to recommendation processing such as exposure, and the delivered service data may refer to the media data that has been delivered to the service object. The service object may refer to a bound account of a service user, in the target application, running the target application (such as an entertainment application, the social application, the video application, etc.) using the terminal device. The service user can log in the target application by using the bound account, and it can be also determined by the bound account whether the service user logs in the target application and acquires related behavior data of the service user in the target application or not. It is to be understood that taking the service data as the advertisement data as an example, the above-mentioned target applications, such as the entertainment application, the social application and the video applications can be used as the advertisement delivery platform. The advertiser (also referred to as the service creation object) who creates the advertisement data can deliver the advertisement data into the advertisement delivery platform. When the advertisement is delivered, service user groups can be targeted-selected for delivery, and different types of advertisement data can be targeted-delivered to different service user groups in the target application, that is, different types of advertisement data will be delivered to different service object sets (referred to as bound accounts corresponding to the service user groups) in the target application.

It can be understood that after the advertisement data is delivered to the service user group, these pieces of advertisement data may be referred to as the delivered advertisement data. Each service user in this service user group can play and watch the delivered advertisement data. After play and watch, each service user can also generate behaviors, such as consumption (such as purchase a commodity in the delivered advertisement data) and download, and the behavior of the service user to consume for or download the delivered advertisement data can be understood as the conversion behavior. One service user consumes or downloads one piece of delivered advertisement data can be understood as one conversion. Taking the consumption (such as purchase) as an example, after a batch of advertisement data is exposed to the service user group A (which may be referred to as a service user set A), for certain advertisement data, if 50 users in the service user set A purchase a certain product through this advertisement data, the conversion quantity of the service user set A for the advertisement data is 50.

It can be understood that the computer device can acquire related data of the delivered advertisement data (including the play and watch behavior of the service user, the conversion behavior, the watch duration, the name of the advertisement data, the type of the advertisement data and the exposure amount of the advertisement data, etc.) through the bound account (i.e., the service object) of the service user group. For example, it can be determined whether the service user has the play and watch behavior on a certain piece of delivered advertisement data, and the service output state in one embodiment can be understood as whether the service user has the play and watch behavior on the delivered advertisement data (having been played and watched can be understood as that the delivered advertisement data is outputted to this service user). If a certain service user has the play and watch behavior on a certain piece of delivered advertisement data, the service output state of the service object corresponding to the service user for the delivered advertisement data may be the outputted state (that is, the service user corresponding to the service object has watched this advertisement data). If a certain service user does not play and watch a certain piece of delivered advertisement data, that is, the service user does not watch the delivered advertisement data, then the service output state of the service object corresponding to the service user for this delivered advertisement data may be the non-outputted state.

Similarly, the computer device can determine whether the service user has the conversion behavior for a certain piece of delivered advertisement data through the bound account of the service user group (which may also be referred to as the service user set), and the service conversion state in one embodiment can be understood as whether the service user has the conversion behavior on the delivered advertisement data. If a certain service user has the conversion behavior for a certain piece of delivered advertisement data, the service conversion state of the service object corresponding to the service user for the delivered advertisement data may be the converted state. If a certain service user has no conversion behavior for a certain piece of delivered advertisement data, the service conversion state of the service object corresponding to the service user for this delivered advertisement data may be the unconverted state.

It can be understood that the play and watch behavior of a certain service user for a certain piece of delivered advertisement data can be generated by a trigger operation performed by the service user for the delivered advertisement data in a display interface of the terminal device. This trigger operation may include a contact operation such as click or long press, or may include a non-contact operation such as a voice or gesture, which will not be limited here. In one embodiment, when a certain service user plays and watches a certain piece of delivered advertisement data (for example, the service user plays the delivered advertisement data by the click operation), the computer device can record the time when the service user generates the click operation. When the service user generates the click operation, the computer device will play this delivered service data to the service object corresponding to the service user, then the service output state of the service object for the delivered advertisement data will also change from the non-outputted state to the outputted state, and therefore, the click operation can also be understood as a state change operation. The record time can also be referred to as the record timestamp for the state change operation.

The related data of the delivered advertisement data acquired by the above-mentioned computer device may be referred to as the delivery log (which may also be referred to as the advertisement log) of the delivered advertisement data. The delivery log may also include the above-mentioned record timestamp therein.
S102: Establish the unconverted browsing behavior features of the target service object for the unconverted service data according to the service output states and service conversion states of the service object set for the N pieces of delivered service data; the service output state of the target service object for the unconverted service data being an outputted state and the service conversion state being an unconverted state; and the N pieces of delivered service data including the unconverted service data, and the service object set including the target service object.

In one embodiment, the delivery log may also include record timestamps of the service object set for the N pieces of delivered service data respectively. Taking the service object set including a service object Mᵢ (i may be any value used for representing a subscript, which is an index variable, for example, i may be a positive integer, or a fraction, etc.), and the N pieces of delivered service data including delivered service data G_{b} (b may be any value used for representing a subscript, which is an index variable, for example, b may be a positive integer, or a fraction, etc.) as an example, the record timestamp of the service object Mᵢ for the delivered service data G_{b} refers to an operation record timestamp of the service object Mᵢ for the state change operation of the delivered service data G_{b}, where the state change operation can be used for indicating that the service output state of the service object Mᵢ for the delivered service data G_{b} changes from the non-outputted state to the outputted state.

The process that the computer device establishes the unconverted browsing behavior features of the target service object for the unconverted service data according to the service output states and service conversion states of the service object set for the N pieces of delivered service data includes: acquiring, by the computer device, an object identifier of the service object Mᵢ and a service identifier of the delivered service data G_{b}; determining by the computer device, a data group composed of the object identifier of the service object the service identifier of the delivered service data G_{b}, the service output state of the service object Mᵢ for the delivered service data G_{b}, the service conversion state of the service object Mᵢ for the delivered service data G_{b}, and the record timestamp of the service object Mᵢ for the delivered service data G_{b} as a browsing behavior feature of the service object Mᵢ for the delivered service data G_{b}; and subsequently, determining by the computer device, from browsing behavior features of the service object set for the N pieces of delivered service data, the unconverted browsing behavior features of the target service object for the unconverted service data.

The process that the computer device determines, from the browsing behavior features of the service object set for the N pieces of delivered service data, the unconverted browsing behavior features of the target service object for the unconverted service data includes: determining by the computer device, a browsing behavior feature that the service output state is the outputted state and the service conversion state is the unconverted state in the browsing behavior features of the service object set for the N pieces of delivered service data as the unconverted browsing behavior feature; subsequently, determining by the computer device, the service object corresponding to the object identifier included in the unconverted browsing behavior feature as the target service object, and determine the delivered service data corresponding to the service identifier included in the unconverted browsing behavior feature as the unconverted service data.

It is to be understood that after the service output state (such as whether there is the play and watch behavior) and the service conversion state (whether there is the conversion behavior) of each service object for the delivered service data are acquired, a data group between one service object and one piece of delivered service data can be established according to the data such as the object identifier (used for representing the service object, which may be an object name, an object ID, etc.) of the service object, the advertisement identifier (used for representing the service data, which may be a service name, a service ID, etc.) of the delivered service data, the service output state, the service conversion state, and the record timestamp that the play and watch behavior is generated. This data group can be used as the browsing behavior feature of the delivered service data for the service object. Subsequently, data groups with the service output state being the outputted state and the service conversion state being the unconverted state are extracted from the established data groups. These extracted data groups may be referred to as the unconverted browsing behavior features (or referred to as unconverted data groups). The service objects included in the unconverted browsing behavior feature may be referred to as the target service object. The delivered service data included in this unconverted browsing behavior feature may be referred to as the unconverted service data. That is, if a service object A plays and watches delivered service data A, but does not generate the conversion behavior for the delivered service data A, the service object A may be referred to as the target service object, the delivered service data A may be referred to as the unconverted service data, and a data group composed of the service object A and the delivered service data A may be referred to as the unconverted browsing behavior feature.

For ease of understanding, a mode to determine the target service object, the unconverted service data and the unconverted browsing behavior feature will be illustrated below. Taking the service object set including the service object A and the delivered service data including delivered advertisement data A as an example, in a period of time, the service object A played and watched the delivered advertisement data A at 19:00 on Aug. 7, 2021 and at 19:06 on Aug. 7, 2021. The service output state of the service object A for the delivered advertisement data A is the outputted state. At the same time, service object A did not generate the conversion behavior after playing and watching at 19:00 on Aug. 7, 2021, and at 19:06 on Aug. 7, 2021. If the outputted state and the converted state are represented by the value 1, and the non-outputted state and the unconverted state are represented by the value 0, then two data groups, including a data group [A, A, 1, 0, 19:00] and a data group [A, A, 1, 0, 19:06], can be formed according to the object identifier (i.e., A) of the service object A, the advertisement identifier (i.e., A) of the delivered advertisement data A, the service output state (1 or 0), the service conversion state (1 or 0) and the record timestamps (19:00, 19:06).

In one embodiment, when the unconverted browsing behavior feature is determined, since the service output state in the data group [A, A, 1, 0, 19:00] and data group [A, A, 1, 0, 19:06] is the outputted state, and the service conversion state is the unconverted state, the computer device can determine these two data groups as the unconverted browsing behavior feature, the service object a can be determined as the target service object, and the delivered advertisement data A is determined as the unconverted service data.
S103: Determine the ranking factor corresponding to both the target service object and an unconverted item according to the unconverted browsing behavior features, rank the service data including the unconverted item according to the ranking factor, to obtain sequenced service data, and select the target service data from the sequenced service data in ranking order and deliver the target service data to the target service object; the unconverted service data including the unconverted item therein.

In one embodiment, the service data may be the advertisement data, and each piece of advertisement data is used for promoting a certain commodity, and the commodity promoted by each piece of advertisement data may be referred to as the service item. Each piece of service data in one embodiment may include one (optionally or multiple, when the service data includes multiple service items therein, any service item can be selected as the service item included in the service data) service item, and the service item included in the unconverted service data may be referred to as the unconverted item. The ranking factor corresponding to both the target service object and the unconverted item can be determined according to the unconverted browsing behavior features corresponding to the unconverted service data. The ranking factor can be used for representing the degree of interest of the target service object in the service item (such as the unconverted item).

It is to be understood that one unconverted browsing behavior feature includes an object identifier of one target service object and a service identifier of one piece of unconverted service data therein, while one piece of unconverted service data includes one unconverted item therein, and multiple pieces of unconverted service data may each include a same unconverted item therein. In one embodiment, the computer device can determine the ranking factor corresponding to both the target service object and the unconverted item by the unconverted browsing behavior features corresponding to multiple (or one) unconverted service data including the same unconverted item respectively. For example, as shown in FIGS. 2a to 2c above, the ranking factor 1 corresponding to both the target service object a1 and the unconverted item “liquid foundation” can be determined according to the unconverted browsing behavior feature 2000a, the unconverted browsing behavior feature 2000b, the unconverted browsing behavior feature 2000c and the unconverted browsing behavior feature 2000d.

That is, in one embodiment, the computer device can determine the ranking factor corresponding to both one target service object and one unconverted item. For the implementation of determining the ranking factor, refer to corresponding descriptions in FIG. 4 below.

In one embodiment, the computer device can rank, based on the ranking factor corresponding to both the target service object and a certain unconverted item, the service data including the unconverted item, and selects the target service data in ranking order and delivers the target service data into the target service object. For ease of understanding, taking the service data including the unconverted item including Q pieces of target unconverted service data, the Q pieces of target unconverted service data each including a same unconverted item Pₓ therein, and the Q pieces of target unconverted service data each including target unconverted service data Rₛ (indicating that each of the Q pieces of target unconverted service data, s is any value used for representing a subscript, for example, s is a positive integer ranging from 1 to Q) as an example, the process that the computer device ranks the service data including the unconverted item to obtain the sequenced service data includes: acquiring by the computer device, the total delivery amount of the target unconverted service data Rₛ for the service object set; determining the real-time delivery conversion rate corresponding to the target unconverted service data Rₛ according to the total delivery amount and the real-time conversion quantity of the service object set for the target unconverted service data Rₛ; and subsequently, ranking by the computer device, service data including the unconverted item Pₓ according to the ranking factor corresponding to both the target service object and the unconverted item Pₓ, and the real-time delivery conversion rates corresponding to the Q pieces of target unconverted service data respectively, to obtain the sequenced service data.

The total delivery amount can be understood as the total exposure amount (also may be understood as the number of exposures of the delivered service data, for example, a certain piece of service data is exposed and displayed to 1000 service objects, the service data may be referred to as the delivered service data, and the exposure amount of the delivered service data is 1000 times). This real-time conversion quantity can be understood as the quantity of the service objects that generate the conversion behavior after the service data is delivered. This real-time conversion quantity is also an indicator to measure the effect of service data delivery, which refers to the quantity of service users who click the service data (such as the advertisement data) and become an effectively activated, registered or paying user. A real-time conversion rate can also be obtained by the real-time conversion quantity (also referred to as the real-time conversion rate, i.e., the number of conversions (quantity) of the advertisement data divided by the click amount (number of clicks) of the advertisement data). The real-time delivery conversion rate (for example, the real-time delivery conversion rate, which may be also referred to as the real-time exposure conversion rate, can be obtained by dividing the real-time conversion quantity by the total delivery amount) of the delivered service data can be obtained according to the real-time conversion quantity and total delivery amount of a certain piece of delivered service data.

In one embodiment, the process that the computer device ranks, when the service data including the unconverted item further includes service data-to-be-delivered including the unconverted item Pₓ, the service data including the unconverted item Pₓ, according to the ranking factor corresponding to both the target service object and the unconverted item Pₓ, and the real-time delivery conversion rates corresponding to the Q pieces of target unconverted service data respectively to obtain the sequenced service data includes: acquiring by the computer device, the service data-to-be-delivered including the unconverted item Pₓ, and a predicted delivery conversion rate corresponding to the service data-to-be-delivered; subsequently, ranking by the computer device, the service data including the unconverted item Pₓ in order of magnitude between a real-time delivery conversion rate corresponding to delivered service data-to-be-ranked and the predicted delivery conversion rate corresponding to the service data-to-be-delivered. Thus, initial sequenced service data can be obtained; acquiring, from the initial sequenced service data, K (K may be a positive integer less than or equal to W, and W is the total quantity of delivered service data-to-be-ranked and the service data-to-be-delivered) pieces of service data with the maximum predicted delivery conversion rate in order; subsequently, acquiring desired conversion unit delivery resources, predicted output rates and predicted conversion rates corresponding to the K pieces of service data; and ranking the K pieces of service data according to the ranking factor corresponding to both the target service object and the unconverted item Pₓ, and the desired conversion unit delivery resources, predicted output rates and predicted conversion rates corresponding to the K pieces of service data to obtain the sequenced service data.

The computer device can acquire from the N pieces of delivered service data, the delivered service data-to-be-ranked including the unconverted item Pₓ; where the delivered service data (i.e., the delivered service data-to-be-ranked) including the unconverted item Pₓ includes the Q pieces of target unconverted service data. In addition, the computer device can determine the delivered service data-to-be-ranked and the service data-to-be-delivered as the service data including the unconverted item Pₓ.

The acquisition process of the sequenced service data i may be the K pieces of service data including service data Rₜ (t is a positive integer), where the K pieces of service data including the service data Rₜ means that the service data Rₜ is any of the K pieces of service data. The process that the computer device ranks the K pieces of service data according to the ranking factor corresponding to both the target service object and the unconverted item Pₓ, and the desired conversion unit delivery resources, predicted output rates and predicted conversion rates corresponding to the K pieces of service data to obtain the sequenced service data includes: determining by the computer device, an initial delivery unit consumed resource corresponding to the service data Rₜ according to the desired conversion unit delivery resource, predicted output rate and predicted conversion rate corresponding to the service data Rₜ; performing arithmetic processing on the ranking factor corresponding to both the target service object and the unconverted item Pₓ and the initial delivery unit consumed resource corresponding to the service data Rₜ to obtain a real-time delivery unit consumed resource corresponding to the service data Rt; and subsequently, ranking by the computer device, the K pieces of service data in order of size between K real-time delivery unit consumed resources. Thus, the sequenced service data can be obtained.

In one embodiment, the computer device can acquire, from the N pieces of delivered service data, the delivered service data that the target service object does not generate the play and watch behavior (that is, the click behavior is not generated, and the service output state of the target service object for the delivered service data is the non-outputted state). These pieces of delivered service data that the play and watch behavior is not generated can be used as non-outputted service data (may be also referred to as unplayed service data, or non-clicked service data). That is, the service data including the unconverted item further includes the non-outputted service data. Thus, the computer device can rank the service data including the unconverted item Pₓ together with the non-outputted service data, that is, the N pieces of delivered service data may further include the non-outputted service data therein, then the process that the computer device ranks the K pieces of service data in order of size between the K real-time delivery unit consumed resources to obtain the sequenced service data includes: acquiring by the computer device, the desired conversion unit delivery resource, predicted output rate and predicted conversion rate corresponding to the non-outputted service data; determining the initial delivery unit consumed resource corresponding to the non-outputted service data according to the desired conversion unit delivery resource, predicted output rate and predicted conversion rate corresponding to the non-outputted service data; and ranking the K pieces of service data and the non-outputted service data in order of size between the initial delivery unit consumed resource corresponding to the non-outputted service data and the K real-time delivery unit consumed resources, to obtain the sequenced service data.

In order to facilitate the understanding of the service data including the unconverted item Pₓ in one embodiment, and the process that the computer device ranks the service data including unconverted item Pₓ and the non-outputted service data based on the ranking factor, the following will be illustrated in combination with FIGS. 2a to 2c above. As shown in FIGS. 2a to 2c, the unconverted item Pₓ may be the unconverted item “liquid foundation”. When the unconverted item is the “liquid foundation”, the ranking factor 1 corresponding to both the target service object a1 and the unconverted item “liquid foundation” is determined. Similarly, the unconverted item Pₓ may be the unconverted item “pure milk”. When the unconverted item is the “pure milk”, the ranking factor 2 corresponding to both the target service object a1 and the unconverted item “pure milk” can be determined. In one embodiment, the computer device can acquire, from the N pieces of delivered service data (i.e., the advertisement data set 20), the delivered advertisement data (including the delivered advertisement data 2001, the delivered advertisement data 2002, the delivered advertisement data 2003, the delivered advertisement data 2004 and the delivered advertisement data 2008) of the unconverted item “liquid foundation” and the delivered advertisement data (including the delivered advertisement data 2005 and the delivered advertisement data 2006) of the unconverted item “pure milk”. Then these pieces of acquired delivered advertisement data may be referred to as the delivered service data including unconverted item Pₓ (i.e., the delivered service data-to-be-ranked including the unconverted item Pₓ).

In one embodiment, the computer device can also acquire, from a candidate service data set (i.e., a set composed of candidate service data waiting to be delivered. None of these pieces of candidate service data has been delivered to the service object set. The candidate service data may also be referred to as the service data-to-be-delivered. The candidate service data set is the candidate advertisement data set. The candidate service data set may include historical service data that is not delivered therein, or may include new added service data that is newly created and not ranked or delivered. The historical service data and the new added service data may be referred to as the candidate service data), the service data-to-be-delivered (for example, the advertisement data-to-be-delivered including the unconverted item “liquid foundation” or the unconverted item “pure milk”. These pieces of advertisement data-to-be-delivered including the unconverted item “liquid foundation” and the above-mentioned delivered service data-to-be-ranked including the unconverted item “liquid foundation” can be made to compose the service data including the unconverted item “liquid foundation”. These pieces of advertisement data-to-be delivered including the unconverted item “pure milk” and the delivered service data-to-be-ranked including the unconverted item “pure milk” can be made to compose the service data including the unconverted item “pure milk”) including the unconverted item Pₓ.

In one embodiment, the computer device can acquire the real-time delivery conversion rates corresponding to the delivered advertisement data 2001, the delivered advertisement data 2002, the delivered advertisement data 2003, the delivered advertisement data 2004, the delivered advertisement data 2008, the delivered advertisement data 2005 and the delivered advertisement data 2006 respectively. At the same time, since the advertisement data-to-be-delivered including the unconverted item “liquid foundation” and the unconverted item “pure milk” is not delivered, there is no real-time delivery conversion rate, then the computer device can acquire the predicted output rate (also referred to as a predicted click through rate (PCTR)) of each of these pieces of advertisement data-to-be-delivered. The predicted click through rate refers to the probability that the advertisement data will be clicked, predicted by an on-line advertisement system, after the advertisement data is delivered in a certain situation. That is, after the computer device delivers certain advertisement data to a certain service object set, the predicted ratio of the quantity of the service objects of this service object set that will click the advertisement data to the total quantity of the service objects of the service object set) and the predicted conversion rate (PCVR). The predicted conversion rate refers to the probability that the clicked-through advertisement data will be converted, predicted by the on-line advertisement system, after the advertisement data is clicked in a certain situation. That is, after the computer device delivers certain advertisement data to a certain service object set, after some of service objects click the advertisement data, the ratio of the quantity of objects of these service objects that will generate the conversion behavior on the advertisement data to the total object quantity of these service objects that perform click), the predicted delivery conversion rate (for example, multiplication arithmetic processing is performed on the predicted click through rate and the predicted conversion rate to obtain the predicted delivery conversion rate) corresponding to the advertisement data-to-be-delivered can be determined according to the predicted click through rate and predicted conversion rate corresponding to each piece of advertisement data-to-be-delivered.

In one embodiment, the computer device can rank these service data including the unconverted item “liquid foundation” and the unconverted item “pure milk” in order of size between the real-time delivery conversion rate and the predicted delivery conversion rate. If the service data-to-be-delivered including the unconverted item “liquid foundation” or the unconverted item “pure milk” is service data-to-be-delivered 20010, the initial sequenced service data obtained after the service data-to-be-delivered is ranked in from-big-to-small order between the real-time delivery conversion rate and the predicted delivery conversion rate is {the delivered advertisement data 2008, the delivered advertisement data 2001, the delivered advertisement data 2006, the delivered advertisement data 2003, the delivered advertisement data 20010, the delivered advertisement data 2002, the delivered advertisement data 2004, and the delivered advertisement data 2005}. In one embodiment, the computer device can acquire the first K pieces of delivered service data from the initial sequenced service data according to the service scenario requirements. Taking K as 5 as an example, the first 5 pieces of delivered advertisement data can be extracted: {the delivered advertisement data 2008, the delivered advertisement data 2001, the delivered advertisement data 2006, the delivered advertisement data 2003 and the delivered advertisement data 20010}.

In one embodiment, the computer device can acquire the desired conversion unit delivery resource (which may refer to the price that the advertiser bids for the advertisement data, for example, the corresponding desired cost price of the advertiser for one conversion, i.e., the cost of one conversion determined by the advertiser), predicted output rate and predicted conversion rate of each of the above-mentioned K pieces of service data, and the initial delivery unit consumed resource corresponding to each piece of service data can be determined according to the desired conversion unit delivery resource, the predicted click through rate and the predicted conversion rate.

In one embodiment, the initial delivery unit consumed resource may refer to the cost that the advertiser needs to pay after a certain advertisement is displayed to 1000 service users. The initial delivery unit consumed resource may also be referred to as cost per mille (CPM). In one embodiment, the CPM can be determined jointly by the desired conversion unit delivery resource, predicted click through rate and predicted conversion rate of the advertiser. For ease of understanding, as shown in Equation (1), Equation (1) is an mode to determine the initial delivery unit consumed resource.

CPM=bid×PCTR×PCVR×1000 Equation (1).

Where CPM may refer to the CPM of certain advertisement data, bid may refer to the desired conversion unit delivery resource of the advertiser (service creation user) for the advertisement data, PCTR may refer to the predicted click through rate of the advertisement data, and PCVR may refer to the predicted conversion rate of the advertisement data. For example, if the predicted click through rate of certain advertisement data R is 0.1, the predicted conversion rate is 0.1, and the desired conversion unit delivery resource is 2, then the CPM of the advertisement data may be 20 (2×0.1×0.1×1000). That is, the advertiser needs to be charged 20 Yuan for every 1000 times of exposure. In general, this real-time CPM can be used as the basis for ranking the advertisement data.

In one embodiment, when the computer device ranks the service data (advertisement data) including the unconverted item, it is also necessary to add the influence of the ranking factor on the basis of the initial delivery unit consumed resource. For example, in the scenarios shown in FIGS. 2a to 2c, for the advertisement data set 20, if the non-outputted service data of the target service object a1 that does not generate the play and watch behavior is the delivered advertisement data 2009, then when ranking is performed, the computer device can obtain the initial delivery unit consumed resource of the delivered advertisement data 2009 by using the above-mentioned Equation (1). Subsequently, the computer device can determine, from the above-mentioned K pieces of service data {the delivered advertisement data 2008, the delivered advertisement data 2001, the delivered advertisement data 2006, the delivered advertisement data 2003, and advertisement data-to-be-delivered 20010}, the initial delivery unit consumed resource corresponding to each piece of service data. In one embodiment, the computer device can acquire the ranking factor 1 corresponding to the target service object a1 and the unconverted item “liquid foundation”, and the ranking factor 2 corresponding to the target service object a1 and the unconverted item “pure milk”. Thus, the computer device can acquire the advertisement data including the unconverted item “liquid foundation” from the K pieces of service data, and performs arithmetic processing on the initial delivery unit consumed resource of each piece of advertisement data including the unconverted item “liquid foundation” and the ranking factor 1 (for example, addition processing), and thereby, the corresponding real-time delivery unit consumed resource can be obtained (i.e., a result of performing the addition processing on the initial delivery unit consumed resource and the ranking factor). Similarly, the computer device can also determine the real-time delivery unit consumed resource corresponding to the advertisement data including the unconverted item “pure milk” through the ranking factor 2 and the initial delivery unit consumed resource corresponding to the advertisement data including the unconverted item “pure milk”. For ease of understanding, refer to Equation (2), Equation (2) is a mode to determine the real-time delivery unit consumed resource.

CPM_{new}=bid×PCTR×PCVR×1000+qualityᵢ Equation (2).

Where CPM_{new} can be used for representing the real-time delivery unit consumed resource of a certain piece of advertisement data; bid×PCTR×PCVR×1000 can be used for representing the initial delivery unit consumed resource of the advertisement data; and qualityᵢ can be used for representing the ranking factor corresponding to both the service item included in the advertisement data and a certain target service object. Through Equation (2), the real-time delivery unit service conversion state corresponding to each of the K pieces of service data {the delivered advertisement data 2008, the delivered advertisement data 2001, the delivered advertisement data 2006, the delivered advertisement data 2003 and the advertisement data-to-be-delivered 20010} can be obtained, and thus, the computer device can rank the K pieces of service data and the delivered advertisement data 2009 (which may also referred to as the non-outputted advertisement data 2009) in order of size between the real-time delivery unit consumed resource and the initial delivery unit consumed resource of the delivered advertisement data 2009 to obtain the sequenced service data (for example, the sequence advertisement data). After ranking the sequenced service data is obtained by ranking, the target service data (for example, the target advertisement data) can be selected from the sequenced service data according to the service scenario requirements and is delivered to the target service object a1 in order. For example, the sequenced service data obtained after the computer device ranks the above-mentioned K pieces of service data {the delivered advertisement data 2008, the delivered advertisement data 2001, the delivered advertisement data 2006, the delivered advertisement data 2003 and the advertisement data-to-be-delivered 20010} and the delivered advertisement data 2009 in order of size (from big to small) between the K real-time delivery unit consumed resources and the initial delivery unit consumed resource of the delivered advertisement data 2009 is {the delivered advertisement data 2008, the delivered advertisement data 2001, the delivered advertisement data 2006, the delivered advertisement data 2009, the delivered advertisement data 2003, and the advertisement data-to-be-delivered 20010}, then at this time, three pieces of advertisement data (i.e., {the delivered advertisement data 2008, the delivered advertisement data 2001 and the delivered advertisement data 2006}) ranking top can be acquired according to the service scenario requirements. These three pieces of advertisement data {the delivered advertisement data 2008, the delivered advertisement data 2001 and the delivered advertisement data 2006} can be used as the target advertisement data (target service data), and these three pieces of target advertisement data can be delivered to the target service object a1 in order.

It is to be understood that when being delivered, the advertisement data-to-be-delivered is usually ranked according to the predicted click through rate and the predicted conversion rate, and then, the advertisement data ranking top (the predicted click through rate and the predicted conversion rate are relatively large) is acquired according to the service scenario requirements and is delivered. However, in one embodiment, if the ranking factor of a certain unconverted item is calculated, and when the advertisement data including the unconverted item and the non-outputted advertisement data are re-ranked, due to the fact that an additional ranking factor is added, for the advertisement data including the unconverted item, there will also be the impact of the ranking factors in addition to the impact of the predicted click through rate and the predicted conversion rate. The ranking factor can improve the probability that the advertisement data including the unconverted item is arranged before other advertisement data, then when the advertisement data is delivered to the target service object, these pieces of advertisement data including the unconverted item are likely to deliver preferentially, which can improve the symbolic degree of the delivered advertisement data and the preference of the target service object. Then the probability that the target service object will generate the conversion behavior can be increased, which can improve the conversion rate.

Refer to FIG. 4, FIG. 4 being a schematic flowchart of another multimedia service data processing method according to an embodiment of this application. This flow can correspond to the flow of determining the ranking factor corresponding to both the target service object and the unconverted item in FIG. 3 above. As shown in FIG. 4, this flow may at least include steps S401 to S403, and each step will be described below.
Step 401: Perform service recognition on the unconverted service data to obtain a mapping relationship between the unconverted service data and the unconverted item; the mapping relationship being used for indicating that the unconverted service data includes the unconverted item.

It is to be understood that the service data may be the advertisement data, and the computer device performs the service recognition on the unconverted service data, i.e., advertisement recognition on the advertisement data. Performing the advertisement recognition on the advertisement data may include perform semantic content recognition on the advertisement data, or may include perform image content recognition on the advertisement data. Performing the advertisement recognition may be that the semantic content recognition is performed by a voice content recognition model, or the image content recognition is performed by an image content recognition model, or both voice content and image content can be recognized, and then a model with higher accuracy is selected for the advertisement recognition. The semantic content recognition model in one embodiment may be any model that includes an advertisement semantic content recognition function, and the image content recognition model may be any model that includes an advertisement image content recognition function, which will not be limited in one embodiment. The computer device can obtain the mapping relationship between the delivered advertisement data and the service items through the semantic content recognition: Rᵢ→Cᵢ, where Rᵢ can be used for representing the advertisement identifier of a certain piece of delivered advertisement data, Cᵢ can be used for representing the item identifier of a certain service item, and this mapping relationship can represent that the delivered advertisement data includes the service item Cᵢ therein. It is to be understood that the service items included in the unconverted service data may be referred to as the unconverted item.
Step 402: Acquire the item identifier of the unconverted item, replace the service identifier of the unconverted service data included in the unconverted browsing behavior feature with the item identifier of the unconverted item, and determine the replaced unconverted browsing behavior feature as the target browsing behavior feature of the target service object for the unconverted item.

In one embodiment, the computer device can replace the service identifier of the unconverted service data in the unconverted browsing behavior feature with the item identifier of the unconverted item. Thus, the target browsing behavior feature of the target service object for the unconverted item can be obtained. For example, as shown in the corresponding scenarios in FIGS. 2a to 2c above, taking the unconverted browsing behavior features as [a1, 2001, 1, 0, 14:00] and [a1, 2002, 1, 0, 14:10] as an example, the advertisement data 2001 and the advertisement data 2002 in the unconverted browsing behavior features each include the unconverted item “liquid foundation”. The item identifier of the unconverted item “liquid foundation” is FDY001. After identifier replacement, the target browsing behavior features of the target service object a1 for the unconverted item “liquid foundation” are [a1, FDY001, 1, 0, 14:00] and [a1, FDY001, 1, 0, 14:10].
Step 403: Determine the ranking factor corresponding to both the target service object and the unconverted item according to the target browsing behavior features.

In one embodiment, the computer device can determine the ranking factor corresponding to both the target service object and the unconverted item according to the target browsing behavior feature of the target service object for the unconverted item. Here, the unconverted service data including the unconverted item includes Q (Q may be an integer less than or equal to N) pieces of target unconverted service data. The Q pieces of target unconverted service data each include the same unconverted item Pₓ (x is any value used for representing a subscript, x may be an integer, fraction, letter, etc.) therein. The target browsing behavior features of the target service object for the unconverted items include Q target browsing behavior features of the target service object for the unconverted item Pₓ. The acquisition process of the ranking factor includes: counting by the computer device, the total feature quantity of the Q target browsing behavior features, and determining the total feature quantity as the total number of outputs of the target service object for the unconverted item Pₓ; acquiring an earliest record timestamp from the record timestamps included in the Q target browsing behavior features respectively; and determining the ranking factor corresponding to both the target service object and the unconverted item Pₓ according to a current timestamp, the total number of outputs and the earliest record timestamp.

To further describe the method of determining the ranking factor, the following will be described in combination with the corresponding descriptions in FIGS. 2a to 2c above. As shown in FIGS. 2a and 2b, for the target service object a1, the unconverted advertisement data 2001, the unconverted advertisement data 2002, the unconverted advertisement data 2003, the unconverted advertisement data 2004, the unconverted advertisement data 2005, and the unconverted advertisement data 2006 are each unconverted advertisement data of the target service object a1. Among these pieces of unconverted advertisement data, the unconverted advertisement data 2001, the unconverted advertisement data 2002, the unconverted advertisement data 2003 and the unconverted advertisement data 2004 each include the same unconverted item “liquid foundation”, then the above-mentioned Q pieces of target unconverted service data may be the unconverted advertisement data 2001, the unconverted advertisement data 2002, the unconverted advertisement data 2003 and the unconverted advertisement data 2004. The above-mentioned unconverted item Pₓ may be the unconverted item “liquid foundation”. The Q target browsing behavior features of the above-mentioned target service object for the unconverted item Pₓ are the target browsing behavior feature 2000a′ of the target service object a1 for the unconverted item “liquid foundation” (obtained through the unconverted browsing behavior feature 2000a), the target browsing behavior feature 2000b′ of the target service object a1 for the unconverted item “liquid foundation” (obtained through the unconverted browsing behavior feature 2000b), the target browsing behavior feature 2000c′ of the target service object a1 for the unconverted item “liquid foundation” (obtained through the unconverted browsing behavior feature 2000c), the target browsing behavior feature 2000d′ of the target service object a1 for the unconverted item “liquid foundation” (obtained through the unconverted browsing behavior feature 2000d).

Similarly, for the target service object a1, among these pieces of unconverted advertisement data, the unconverted advertisement data 2005 and the unconverted advertisement data 2006 each include the same unconverted item “pure milk”, then the above-mentioned Q pieces of unconverted service data may be unconverted advertisement data 2005 and unconverted advertisement data 2006; The above-mentioned unconverted item Pₓ may be the unconverted item “pure milk”. The Q target browsing behavior features of the above-mentioned target service object for the unconverted item Pₓ are the target browsing behavior feature 2000e′ of the target service object a1 for the unconverted item “pure milk” (obtained through the unconverted browsing behavior feature 2000e), and the target browsing behavior feature 2000f′ of the target service object a1 for the unconverted item “pure milk” (obtained through the unconverted browsing behavior feature 2000f).

In one embodiment, the computer device can determine the ranking factor corresponding to both the target service object and this unconverted item according to the target browsing behavior feature of the target service object for a certain unconverted item. For example, as shown in FIG. 2c, the computer device can determine the ranking factor 1 corresponding to both the target service object a1 and the unconverted item “liquid foundation” according to the target browsing behavior feature (including the target browsing behavior feature 2000a′, the target browsing behavior feature 2000b′, the target browsing behavior feature 2000c′ and the target browsing behavior feature 2000d′) of the target service object a1 for the unconverted item “liquid foundation”, including: determining by the computer device, the total number of clicks (referred to as the total number of outputs) of the target service object a1 for the unconverted item according to the target browsing behavior feature of target service object a1 for the unconverted item “liquid foundation”. Since one target browsing behavior feature corresponds to one click behavior (that is, the target service object generates a play and watch behavior for certain unconverted advertisement data), the total number of clicks is equivalent to the total feature quantity of these target browsing behavior features. Since each target browsing behavior feature of the target service object a1 for the unconverted item “liquid foundation” includes a record timestamp (i.e., the time or moment when the play and watch behavior is generated) of the service output state therein, the computer device can acquire a minimum record timestamp (may be also referred to as the earliest record timestamp or the earliest moment, which is the earliest click time (or the earliest click moment), i.e., the earliest time when the play and watch behavior is generated) from the target browsing behavior features of the target service object a1 for the unconverted item “liquid foundation”; subsequently, determining by the computer device, the ranking factor corresponding to both the target service object a1 and the unconverted item “liquid foundation” according to the current time (the current moment, referred to as the current timestamp), the minimum record timestamp and the total number of clicks.

For ease of understanding, refer to Equation (3), Equation (3) being a mode to determine the ranking factor based on the current time, the minimum record timestamp, and total number of clicks, as shown below.

$${quality}_{i} = \sum {click}_{i} * \frac{1}{{e}^{α * ( t - {t}_{0} )}} . \qquad Equation ( 3 )$$

Where Σclickᵢ in Equation (3) can be used for representing the total number of clicks (such as the total number of clicks of the above-mentioned target service object for the unconverted item “liquid foundation”) of a certain target service object for a certain service item.t in Equation (3) can be used for representing the current time (or referred to as the current moment). In Equation (3), t₀ can be used for representing the earliest moment when the earliest click behavior of the target service object is generated for a certain service item. In Equation (3), e^{α} is an exponential function, qualityᵢ can be used for representing the ranking factor of the target service object for a certain service item.

In one embodiment, the unconverted browsing behavior features of the target service object for the unconverted service data are established through the service output states and service conversion states of the service object set for the N pieces of delivered service data, and the ranking factor corresponding to both the target service object and the unconverted item (i.e., the service item included in the unconverted service data) is determined according to the unconverted browsing behavior feature. Subsequently, the service data including the unconverted item is ranked according to the ranking factor, and the target service data is selected and is delivered to the target service object in order. It can be understood that in the above-mentioned process of delivering the target service data to the target service object, the target service object does not generate the conversion behavior on the unconverted service data, but since the service output state of the unconverted service data is the outputted state, it can still indicate that the target service object is interested in the service items in the unconverted service data. That is, the unconverted service data that is in the outputted state and unconverted state for the target service object can be determined according to the real-time feedback data of the target service object on the delivered service data in one embodiment, and these pieces of unconverted service data can indicate the potential preferences of the target service object, and the service data including the unconverted item is ranked and delivered according to the preferences, such that the delivered service data conforms to the preferences of the target service object. As a result, the accuracy can be improved, and the data transmission cost can be reduced. Moreover, since the delivered data conforms to the preferences of the target service object, the probability that the target service object generates the conversion behavior can be increased, thus improving the conversion rate. To sum up, the delivery accuracy of the service data can be improved, the data transmission cost is reduced, and the conversion rate of the service data is improved in one embodiment.

It can be understood that through the corresponding descriptions in FIGS. 3 and 4 above, it can be seen that for a certain target service object, the target service data (the target service data may be complete sequenced service data or part of the sequenced service data) in the sequenced service data can be delivered into the target service object within a target time period. In this delivery process, the computer device can acquire browsing feedback data of the target service object for each piece of service data in the target service data, and thus, the computer device can perform subsequent processing (for example, stop the delivery of the sequenced service data; or perform similar service data recommendation processing, etc.) based on the browsing feedback data. For ease of understanding, refer to FIG. 5, FIG. 5 being a schematic diagram of similar service data recommendation processing based on browsing feedback data of a target service object in an embodiment of this application. As shown in FIG. 5, this flow may at least include the following steps S501 to S502, and each step will be described below.
S501: Acquire the browsing feedback data of the target service object for the target service data within the target time period.

In one embodiment, for each piece of service data (advertisement data) in the target service data, a service user corresponding to the target service object can play and watch by clicking the trigger operation, and generates the conversion behavior after play and watch, then the browsing feedback data may be conversion feedback behavior data at this time. Correspondingly, the service user corresponding to the target service object can also indicate his/her negative preference for a certain piece of service data by clicking a negative feedback control (such as a close control, a stop control, an uninterested control and an advertisement grumble control), then the browsing feedback data may be negative feedback behavior data at this time. Correspondingly, after the service user corresponding to the target service object plays and watches a certain piece of service data, that is, the service data is browsed and watched, and the computer device can also count the target browse duration of the service user for the service data within the target time period, that is, the browsing feedback data may be the target browse duration of the target service object for a certain piece of service data. Thus, the browsing feedback data includes at least one of: the conversion feedback behavior data of the target service object for the target service data, the negative feedback behavior data of the target service object for the target service data, and the target browse duration of the target service object for the target service data.
S502: Perform similar service data delivery processing on the target service object according to the browsing feedback data.

In one embodiment, the process that the computer device performs the similar service data recommendation processing on the target service object when the browsing feedback data includes the conversion feedback behavior data of the target service object for the sequenced service data includes: acquiring by the computer device, from the target service data, converted service data corresponding to the conversion feedback behavior data; acquiring converted items included in the converted service data, and acquiring first similar items of the converted items; and taking service data to which the first similar items belong as target similar service data, and delivering the target similar service data to the target service object. It is to be understood that after the target service data is delivered, if the target service object generates the conversion behavior on service data A including a service item “whitening facial mask”, then the service item “whitening facial mask” may be referred to as a converted item, which can indicate that the target service object is interested in the service item “whitening facial mask” at this time, then at this time, the computer device can deliver the corresponding service data including similar items (items of a same type, such as whitening essence and whitening cream) to the target service object according to the preference of the target service object.

In one embodiment, the process that the computer device performs the similar service data recommendation processing on the target service object when the browsing feedback data includes the negative feedback behavior data of the target service object for the target service data includes: acquiring by the computer device, from the target service data, negative feedback service data corresponding to the negative feedback behavior data; acquiring negative feedback items included in the negative feedback service data, and acquiring second similar items of the negative feedback items; and taking service data to which the second similar items belong as target similar service data, and filtering the target similar service data in a service data delivery process for the target service object. It is to be understood that after the target service data is delivered, if the target service object generates the negative feedback behavior data on the service data A including the service item “whitening facial mask”, then the service item “whitening facial mask” may be referred to as a negative feedback item, which can indicate that the target service object is not interested in the item “whitening facial mask”, then at this time, the computer device can no longer deliver the corresponding service data including the similar items (items of the same type, such as the whitening essence and the whitening cream) to the target service object according to the preference of the target service object when a new round of delivery (delivery in the next time period of the target time period) is performed to the target service object.

In one embodiment, the process that the computer device performs the similar service data recommendation processing on the target service object when the browsing feedback data includes the browse duration of the target service object for the target service data includes: acquiring by the computer device, the historical average browse duration of the target service object for the target service data; determining the service items included in the target service data as potential converted items when the target browse duration is longer than the historical average browse duration, and taking service data to which third similar items of the potential converted items belong as target similar service data, and delivering the target similar service data to the target service object; where the computer device can acquire the target browse duration of the target service object for the target service data in the process of delivering the target service data to the target service object. It is to be understood that if the target browse duration of the target service object for a certain piece of service data in the target service data is greater than the historical average browse duration of the target service object for the service data, it can indicate that the interest of the target service object in the service data increases during the delivery process. In the new round of delivery process, the service data including similar items of the same type can be delivered to the target service object.

It is to be understood that in one embodiment, the preference of the target service object can be determined according to the real-time feedback data (such as the browsing feedback data) of the target service object for the sequenced service data and based on the browsing feedback data, and corresponding service processing is performed. When the target service object generates the conversion behavior, the service data of the same type can be further delivered to the target service object. When the target service object generates a negative feedback behavior, the delivery of the sequenced service data can be stopped in time, and the service data of the same type is no longer delivered to the target service object within a certain period of time. When the browse duration of the target service object increases, the service data of the same type can also be further delivered to the target service object. That is, through the real-time feedback data of the target service object, the accuracy of delivering the service data to the target service object can be improved, the conversion rate corresponding to the target service object can be increased, and the user experience can be promoted.

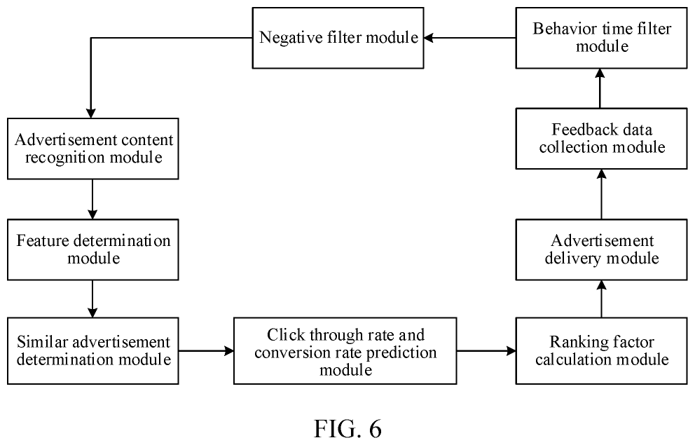

Refer to FIG. 6, FIG. 6 being a schematic structure diagram of a server according to an embodiment of this application. As shown in FIG. 6, the system structure may include an advertisement content recognition module, a feature determination module, a similar advertisement determination module, a click through rate and conversion rate prediction module, a ranking factor calculation module, an advertisement delivery module, a feedback data collection module, a behavior time filter module and a negative filter module.

The advertisement content recognition module can be configured to perform at least one of semantic content recognition and image content recognition on the advertisement data. The feature determination module can be configured to determine the browsing behavior features of the target service object (may refer to the service object corresponding to the service user who generates the click behavior but does not generate the conversion behavior, or may also be referred to as the service object corresponding to a click unconverted user) for a certain unconverted item. The similar advertisement determination module can be configured to acquire all advertisement data including the same unconverted item. The click through rate and predicted volume prediction module can be configured to predict the click through rate and conversion rate of each piece of advertisement data. The ranking factor calculation module can be configured to determine the ranking factor corresponding to both a certain target service object and a certain unconverted item. The advertisement delivery module can rank the advertisement data based on the ranking factor calculated by the ranking factor calculation module and acquire part of the advertisement data according to the service scenario requirements for delivery. The feedback data collection module can be configured to collect the browsing feedback data (for example, click behavior data, conversion behavior data, etc.) of each service object for each piece of service data. It is to be understood that in one embodiment, the click unconverted user, the unconverted advertisement data corresponding to the click unconverted user and the like can be determined based on the browsing feedback data of the service object. Since the conversion demand of the service object has a validity period, a time window of a user's click unconverted behavior can be extracted in one embodiment. For example, taking the click unconverted behavior in the last T days, assuming that the current moment is recorded as now, then the service object that generates the click unconverted behavior for a certain piece of delivered advertisement data during the time period from now-T to now can be extracted. The service object can be used as the target service object, and the delivered advertisement data can be used as the unconverted service data. The negative filter module can be configured to filter the advertisement data that the service object generates the negative feedback behavior data.

Each module in FIG. 6 can be configured to implement the flows corresponding to FIGS. 3 to 5 above. For the implementation of each module, refer to the corresponding descriptions in FIGS. 3 to 5 above, which will not be described herein again.

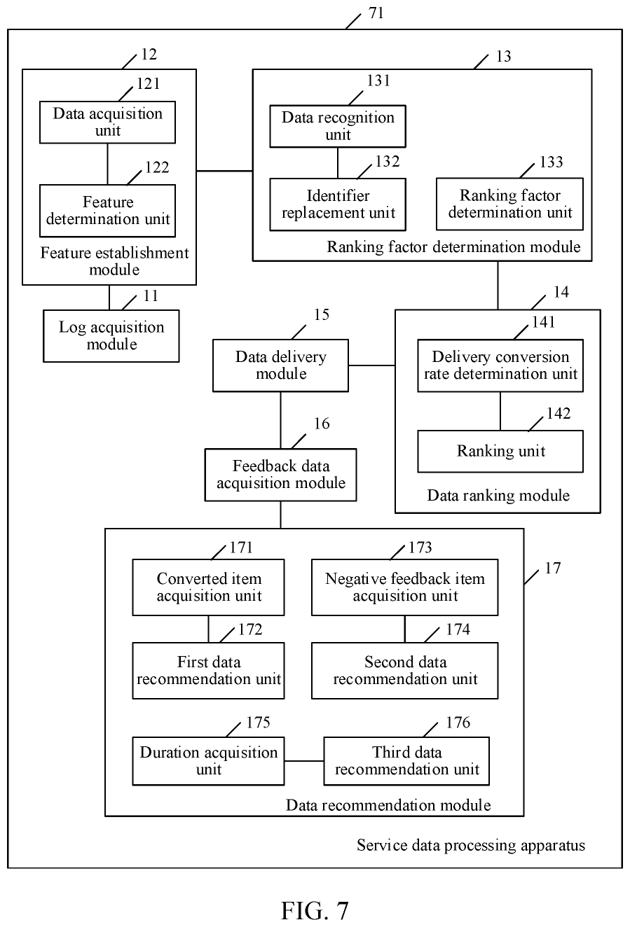

Refer to FIG. 7, FIG. 7 being a schematic structural diagram of another multimedia service data processing apparatus according to an embodiment of this application. The service data processing apparatus can be a computer program (including a program code) running in the electronic device such as the computer device, for example, the service data processing apparatus is application software. The service data processing apparatus can be configured to perform the method shown in FIG. 3. As shown in FIG. 7, the service data processing apparatus 71 may include: a log acquisition module 11, a feature establishment module 12, a ranking factor determination module 13, a data ranking module 14, and a data delivery module 15.

The log acquisition module 11 is configured to acquire delivery logs corresponding to N pieces of delivered service data. The delivery log includes the service output states and service conversion states of a service object set for the N pieces of delivered service data. N is a positive integer. The service conversion state includes an unconverted state. The service output state includes an outputted state;

The feature establishment module 12 is configured to establish unconverted browsing behavior features of a target service object for unconverted service data according to the service output states and service conversion states of the service object set for the N pieces of delivered service data. The service output state of the target service object for the unconverted service data is the output state and the service conversion state is the unconverted state. The N pieces of delivered service data include the unconverted service data, and the service object set includes the target service object.

The ranking factor determination module 13 is configured to determine a ranking factor corresponding to both the target service object and an unconverted item according to the unconverted browsing behavior features. The unconverted service data includes the unconverted item therein.

The data ranking module 14 is configured to rank, according to the ranking factor, service data including the unconverted item to obtain sequenced service data.

The data delivery module 15 is configured to select target service data from the sequenced service data in ranking order and deliver the target service data to the target service object.

For embodiments of the log acquisition module 11, the feature establishment module 12, the ranking factor determination module 13, the data ranking module 14, and the data delivery module 15, refer to the descriptions of steps S101 to S103 in the corresponding embodiment in FIG. 3 above, which will not be described herein again.

In one embodiment, the delivery log may further include record timestamps of the service object set for the N pieces of delivered service data respectively. The service object set includes the service object Mᵢ. The N pieces of delivered service data include the delivered service data G_{b}. The record timestamp of the service object Mᵢ for the delivered service data G_{b} refers to the operation record timestamp of the state change operation of the service object Mᵢ for the delivered service data G_{b}. The state change operation is used for indicating that the service output state of the service object Mᵢ for the delivered service data G_{b} is converted from the non-outputted state to the outputted state. i and b are both a positive integer.

The feature establishment module 12 includes: a data acquisition unit 121 and a feature determination unit 122.

The data acquisition unit 121 is configured to acquire an object identifier of the service object Mᵢ and a service identifier of the delivered service data G_{b}.

The feature determination unit 122 is configured to determine the data group composed of the object identifier of the service object Mᵢ, the service identifier of the delivered service data G_{b}, the service output state of the service object Mᵢ for the delivered service data G_{b}, the service conversion state of the service object Mᵢ for the delivered service data G_{b}, and the record timestamp of the service object Mᵢ for the delivered service data G_{b} as browsing behavior features of the service object Mᵢ for the delivered service data G_{b}.

The feature determination unit 122 is further configured to determine, from the browsing behavior features of the service object set for the N pieces of delivered service data, the unconverted browsing behavior features of the target service object for the unconverted service data.

For the implementations of the data acquisition unit 121 and the feature determination unit 122, refer to the description of the corresponding step S102 in FIG. 3 above, which will not be described herein again.

In one embodiment, the feature determination unit 122 is further configured to determine, from the browsing behavior features of the service object set for the N pieces of delivered service data, the browsing behavior feature that the service output state is the outputted state and the service conversion state is the unconverted state as the unconverted browsing behavior feature.

The feature determination unit 122 is further configured to determine the service object corresponding to the object identifier included in the unconverted browsing behavior feature as the target service object, and determine, from the unconverted browsing behavior feature including the object identifier of the target service object, the delivered service data corresponding to the service identifier included as the unconverted service data at which the target service object targets, to obtain the unconverted browsing behavior features of the target service object for the unconverted service data.

In one embodiment, the ranking factor determination module 13 may include: a data recognition unit 131, an identifier replacement unit 132, and a ranking factor determination unit 133.

The data recognition unit 131 is configured to perform service recognition on the unconverted service data, to obtain the mapping relationship between the unconverted service data and the unconverted item. The mapping relationship is used for indicating that the unconverted service data includes the unconverted item.

The identifier replacement unit 132 is configured to acquire the item identifier of the unconverted item, replace the service identifier of the unconverted service data included in the unconverted browsing behavior feature with the item identifier of the unconverted item, and determine the replaced unconverted browsing behavior feature as the target browsing behavior feature of the target service object for the unconverted item.

The ranking factor determination module 133 is configured to determine the ranking factor corresponding to both the target service object and the unconverted item according to the target browsing behavior features.

For the implementations of the data recognition unit 131, the identifier replacement unit 132 and the ranking factor determination module 133, refer to the descriptions of the corresponding steps S401 to S403 in FIG. 4 above, which will not be described herein again.

In one embodiment, the ranking factor determination module 133 is further configured to count the total feature quantity of the Q target browsing behavior features, and determine the total feature quantity as the total number of outputs of the target service object for the unconverted item Pₓ.

The ranking factor determination module 133 is further configured to acquire the earliest record timestamp from the record timestamps included in the Q target browsing behavior features respectively.

The ranking factor determination module 133 is further configured to determine the ranking factor corresponding to both the target service object and the unconverted item Pₓ according to the current timestamp, the total number of outputs and the earliest record timestamp.

In one embodiment, the service data including the unconverted item includes the Q pieces of target unconverted service data. The Q pieces of target unconverted service data may include a same unconverted item Px therein. Q is a positive integer less than or equal to N, and x is a positive integer. In some embodiments, some or all of the Q pieces of target unconverted service data may include a same unconverted item Px therein.

The data ranking module 14 may include: a delivery conversion rate determination unit 141 and a ranking unit 142.

The delivery conversion rate determination unit 141 is configured to acquire the total delivery amount of the target unconverted service data Rₛ for the service object set. The target unconverted service data Rₛ is any of the Q pieces of target unconverted service data.

The delivery conversion rate determination unit 141 is further configured to determine the real-time delivery conversion corresponding to the target unconverted service data Its according to the total delivery amount and the real-time conversion quantity of the service object set for the target unconverted service data Rₛ.

The ranking unit 142 is configured to rank the service data including the unconverted item Pₓ according to the ranking factor and the real-time delivery conversion rates corresponding to the Q pieces of target unconverted service data respectively to obtain the sequenced service data.

For the implementations of the delivery conversion rate determination unit 141 and the ranking unit 142, refer to the descriptions of the corresponding step S103 in FIG. 3 above, which will not be described herein again.

In one embodiment, the ranking unit 142 is further configured to acquire the predicted delivery conversion rate corresponding to the service data-to-be-delivered. The service data including the unconverted item further includes the service data-to-be-delivered including the unconverted item Pₓ.

The ranking unit 142 is further configured to rank the service data including the unconverted item Pₓ in order of magnitude between the real-time delivery conversion rates corresponding to the Q pieces of target unconverted service data respectively and the predicted delivery conversion rate corresponding to the service data-to-be-delivered to obtain the initial sequenced service data.

The ranking unit 142 is further configured to acquire from the initial sequenced service data, K pieces of service data with the maximum predicted delivery conversion rate in order. K is a positive integer less than W. W is the total quantity of the Q pieces of target unconverted service data and the service data-to-be-delivered including the unconverted item Pₓ.

The ranking unit 142 is further configured to acquire desired conversion unit delivery resources, predicted output rates, and predicted conversion rates corresponding to the K pieces of service data.

The ranking unit 142 is further configured to rank the K pieces of service data according to the ranking factor and the desired conversion unit delivery resources, predicted output rates and predicted conversion rates corresponding to the K pieces of service data to obtain the sequenced service data.

In one embodiment, the service data Rₜ is any of the K pieces of service data. t is a positive integer.

The ranking unit 142 is further configured to determine the initial delivery unit consumed resource corresponding to the service data Rₜ according to the desired conversion unit delivery resources, predicted output rates and predicted conversion rates corresponding to the service data Rₜ.

The ranking unit 142 is further configured to perform arithmetic processing on the ranking factor and the initial delivery unit consumed resource corresponding to the target service data Rₜ, to obtain the real-time delivery unit service conversion state corresponding to the target service data Rₜ.

The ranking unit 142 is further configured to rank the K pieces of service data in order of size between the K real-time delivery unit consumed resources to obtain the sequenced service data.

In one embodiment, the service data including the unconverted item further includes the non-outputted service data. The service output state of the target services object for the non-outputted service data is the non-outputted state.

The ranking unit 142 is further configured to acquire the desired conversion unit delivery resource, predicted output rate, and predicted conversion rate corresponding to the non-outputted service data.

The ranking unit 142 is further configured to determine, according to the desired conversion unit delivery resource, predicted output rate, and predicted conversion rate corresponding to the non-outputted service data, the initial delivery unit consumed resource corresponding to the non-outputted service data.

The ranking unit 142 is further configured to rank the K pieces of service data and the non-outputted service data in order of size between the initial delivery unit consumed resource corresponding to the non-outputted service data and the K real-time delivery unit consumed resources, to obtain the sequenced service data.

In one embodiment, the service data processing apparatus 71 can further include: a feedback data acquisition module 16 and a data recommendation module 17.

The feedback data acquisition module 16 is configured to acquire the browsing feedback data of the target service object for the target service data within the target time period.

The data recommendation module 17 is configured to perform similar service data delivery processing on the target service object according to the browsing feedback data.

For the implementations of the feedback data acquisition module 16 and the data recommendation module 17, refer to the descriptions of corresponding steps S501 to S502 in FIG. 5 above, which will not be described herein again.

In one embodiment, the browsing feedback data includes the conversion feedback behavior data of the target service object for the target service data.

The data recommendation module 17 may include: a converted item acquisition unit 171 and a first data recommendation unit 172.

The converted item acquisition unit 171 is configured to acquire, from the target service data, the converted service data corresponding to the conversion feedback behavior data.

The converted item acquisition unit 171 is further configured to acquire the converted items included in the converted service data, and acquire the first similar items of the converted items.

The first data recommendation unit 172 is configured to take the service data to which the first similar items belong as target similar service data, and deliver the target similar service data to the target service object.

For the implementations of the converted item acquisition unit 171 and the first data recommendation unit 172, refer to the description of the corresponding step S502 in FIG. 5 above, which will not be described herein again.

In one embodiment, the browsing feedback data includes the negative feedback behavior data of the target service object for the target service data.

The data recommendation module 17 may include: a negative feedback item acquisition unit 173 and a second data recommendation unit 174.

The negative feedback item acquisition unit 173 is configured to acquire, from the target service data, the negative feedback service data corresponding to the negative feedback behavior data.

The negative feedback item acquisition unit 173 is configured to acquire the negative feedback items included in the negative feedback service data, and acquire the second similar items of the negative feedback items.

The second data recommendation unit 174 is configured to take the service data to which the second similar items belong as target similar service data, and filter the target similar service data in a service data delivery process for the target service object.

For the implementations of the negative feedback item acquisition unit 173 and the second data recommendation unit 174, refer to the description of the corresponding step S502 in FIG. 5 above, which will not be described herein again.

In one embodiment, the browsing feedback data includes the browse duration of the target service object for the target service data.

The data recommendation module 17 may include: a duration acquisition unit 175 and a third data recommendation unit 176.

The duration acquisition unit 175 is configured to acquire the historical average browse duration of the target service object for the target service data.

The third data recommendation unit 176 is configured to determine the service items included in the target service data as the potential converted items when the target browse duration is longer than the historical average browse duration, and take the service data to which third similar items of the potential converted items belong as target similar service data, and deliver the target similar service data to the target service object.

For the implementations of the duration acquisition unit 175 and the third data recommendation unit 176, refer to the description of the corresponding step S502 in FIG. 5 above, which will not be described herein again.

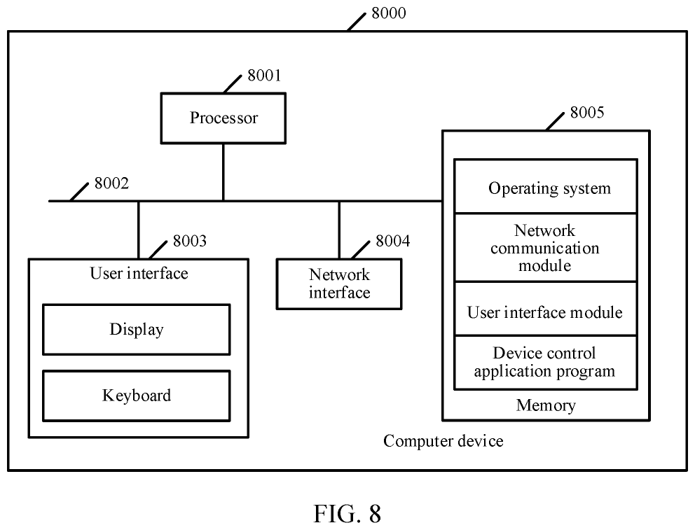

Refer to FIG. 8, FIG. 8 being a schematic structural diagram of a computer device according to an embodiment of this application. As shown in FIG. 8, the service data processing apparatus 71 in the corresponding embodiment in FIG. 7 above can be applied to the above-mentioned computer device 8000 (referred to as the electronic device). The above-mentioned computer device 8000 may include: a processor 8001, a network interface 8004 and a memory 8005. Furthermore, the above-mentioned computer device 8000 further includes: a user interface 8003 and at least one communication bus 8002. The communication bus 8002 is configured to implement connections and communications between these components. The user interface 8003 may include a display and a keyboard. The user interface 8003 may further include a standard wired interface and a standard wireless interface. The network interface 8004 may include a standard wired interface and a standard wireless interface (such as a Wi-Fi interface). The memory 8005 may be a high-speed RAM memory, or a non-volatile memory, for example, at least one magnetic disk memory. The memory 8005 may be at least one storing apparatus located away from the aforementioned processor 8001. As shown in FIG. 8, the memory 8005 used as a computer storage medium may include an operating system, a network communication module, a user interface module, and a device-control application program therein.

In the computer device 8000 shown in FIG. 8, the network interface 8004 can provide a network communication function. The user interface 8003 is an interface mainly configured to provide input for a user. The processor 8001 may be configured to invoke a device control application program stored in the memory 8005 to implement the service data processing method in one embodiment.

The computer device 8000 described in one embodiment can perform the corresponding descriptions of the service data processing methods in FIGS. 3 to 5, or can also perform the corresponding descriptions of the service data processing apparatus 71 in FIG. 7, which will not be described herein again. In addition, the description of beneficial effects of the same method is not described herein again.

One embodiment further provides a computer-readable storage medium. The computer program executed by the computer device 8000 is stored in the above-mentioned computer-readable storage medium, and the above-mentioned computer program includes a program instruction. The above-mentioned program instruction, when executed by the above-mentioned processor, can perform the corresponding service data processing methods in FIGS. 3 to 5, which therefore will not be described herein again. In addition, the description of beneficial effects of the same method is not described herein again.

The above-mentioned computer-readable storage medium may be the service data processing apparatus, or an internal storage unit of the computer device, such as a hard disk or internal memory of the computer device. The computer-readable storage medium may also be an external storing device of the computer device, such as a plug-in hard disk, a smart media card (SMC), a secure digital (SD) card and a flash card equipped on the computer device. In one embodiment, the computer-readable storage medium may also include both the internal storage unit of the computer device and the external storing device. The computer-readable storage medium is configured to store the computer program and other programs and data required by the computer device. The computer-readable storage medium can be further configured to temporarily store data that has been outputted or will be outputted.

One embodiment provides a computer program product or computer program. The computer program product or computer program includes a computer instruction. The computer instruction is stored in the computer-readable storage medium. The processor of the computer device reads the computer instruction from the computer-readable storage medium, and the processor executes the computer instruction, such that the computer device performs the service data processing method in one embodiment.

The terms “first”, “second” and “third” in this specification, claims, and the accompanying drawings of one embodiment are used for distinguishing different objects and are not used for describing a specific sequence. Furthermore, the term “include”, and any variant thereof are intended to cover a non-exclusive inclusion. For example, processes, methods, apparatuses, products, or devices that include a series of steps or units is not limited to the listed steps or modules, but may further include a step or module that is not listed, or may further include other steps or units that are intrinsic to these processes, methods, apparatuses, or devices.

A person of ordinary skill in the art can realize that, units and algorithm steps of each example in combination with the disclosed descriptions in one embodiment may be implemented by electronic hardware, computer software, or a combination thereof. To clearly describe the interchangeability between the hardware and the software, the composition and steps of each example have been described in general terms according to the functions in the above description. Whether the functions are executed in a mode of hardware or software depends on particular applications and design constraint conditions of the technical solutions. A person skilled in the art may use different methods to implement the described functions for each particular application, but such implementation may not be considered beyond the scope of this application.

The method and related apparatus in one embodiment are described with reference to the method flowchart and/or structural schematic diagram. Each flow and/or block in the method flowchart and/or structural schematic diagram, as well as the combination of flows and/or blocks in the flowchart and/or block diagram, can be implemented by computer program instructions. These computer program instructions may be provided to a general-purpose computer, a dedicated computer, an embedded processor, or processors of other programmable data processing devices to generate a machine, so that the instructions executed by the computer or the processors of the other programmable data processing devices generate an apparatus for implementing a specific function in one or more flows in the flowcharts and/or in one or more blocks in the structural schematic diagrams. These computer program instructions may also be stored in a computer-readable memory that can instruct the computer or other programmable data processing devices to work in a specific manner, so that the instructions stored in the computer-readable memory generate an artifact that includes an instruction apparatus. The instruction apparatus implements the specific function in one or more flows in the flowcharts and/or in one or more blocks in the structural schematic diagrams. These computer program instructions may also be loaded onto a computer or other programmable data processing device, so that a series of operation steps are performed on the computer or the other programmable device to generate computer-implemented processing. Therefore, the instructions executed on the computer, or the other programmable device provide steps for implementing the specific function in one or more flows in the flowcharts and/or in one or more blocks in the structural schematic diagrams.

It is to be understood that in one embodiment, the delivery logs and other related data are involved. When one embodiment is applied to specific products or technologies, the user's permission or consent is required, and the collection, use and processing of the related data need to comply with the relevant laws, regulations and standards of relevant countries and regions.

What is disclosed above is merely embodiments of this application, and certainly is not intended to limit the scope of the claims of this application. Therefore, equivalent variations made in accordance with the claims of this application shall fall within the scope of this application.

What is claimed is:

1. A service data processing method, the method being performed by an electronic device, and comprising:
acquiring a delivery log corresponding to N pieces of delivered service data, the delivery log comprising service output states and service conversion states of a service object set for the N pieces of delivered service data, N being a positive integer; the service conversion state comprising an unconverted state, the service output state comprising an outputted state;
establishing unconverted browsing behavior features of a target service object for unconverted service data according to the service output states and service conversion states of the service object set for the N pieces of delivered service data, the service output state of the target service object for the unconverted service data being the outputted state and the service conversion state being the unconverted state, the N pieces of delivered service data comprising the unconverted service data, the unconverted service data comprising an unconverted item, and the service object set comprising the target service object;
determining a ranking factor corresponding to both the target service object and the unconverted item according to the unconverted browsing behavior features; and
ranking service data comprising the unconverted item to obtain sequenced service data according to the ranking factor, and selecting target service data from the sequenced service data according to ranking order and delivering the target service data to the target service object.

2. The method according to claim 1, wherein the delivery log further comprises record timestamps of the service object set for the N pieces of delivered service data respectively; the service object set comprising a service object the N pieces of delivered service data comprising delivered service data G_{b}, the record timestamp of the service object Mᵢ for the delivered service data G_{b} referring to an operation record timestamp of a state change operation of the service object Mᵢ for the delivered service data G_{b}, the state change operation indicating that the service output state of the service object Mᵢ for the delivered service data G_{b} is converted from a non-outputted state to the outputted state; i and b being both a positive integer;
the establishing the unconverted browsing behavior features of the target service object for the unconverted service data according to the service output states and service conversion states of the service object set for the N pieces of delivered service data comprises:
acquiring an object identifier of the service object Mᵢ and a service identifier of the delivered service data G_{b};
determining a data group composed of the object identifier of the service object Mᵢ, the service identifier of the delivered service data G_{b}, the service output state of the service object Mᵢ for the delivered service data G_{b}, the service conversion state of the service object Mᵢ for the delivered service data G_{b}, and the record timestamp of the service object Mi for the delivered service data G_{b} as a browsing behavior feature of the service object Mᵢ for the delivered service data G_{b}; and
determining the unconverted browsing behavior features of the target service object for the unconverted service data from the browsing behavior features of the service object set for the N pieces of delivered service data.

3. The method according to claim 2, wherein the determining, from the browsing behavior features of the service object set for the N pieces of delivered service data, the unconverted browsing behavior features of the target service object for the unconverted service data comprises:
determining the browsing behavior feature that the service output state is the outputted state and the service conversion state is the unconverted state as the unconverted browsing behavior feature from the browsing behavior features of the service object set for the N pieces of delivered service data; and
determining a service object corresponding to the object identifier comprised in the unconverted browsing behavior feature as the target service object, and determining, from the unconverted browsing behavior feature comprising the object identifier of the target service object, delivered service data corresponding to the service identifier comprised as the unconverted service data at which the target service object targets, to obtain the unconverted browsing behavior features of the target service object for the unconverted service data.

4. The method according to claim 1, wherein the determining the ranking factor corresponding to both the target service object and an unconverted item according to the unconverted browsing behavior features comprises:
performing service recognition on the unconverted service data to obtain a mapping relationship between the unconverted service data and the unconverted item; the mapping relationship indicating that the unconverted service data comprises the unconverted item;
acquiring an item identifier of the unconverted item, replacing a service identifier of the unconverted service data comprised in the unconverted browsing behavior feature with the item identifier of the unconverted item, and determining the replaced unconverted browsing behavior feature as a target browsing behavior feature of the target service object for the unconverted item; and
determining the ranking factor corresponding to both the target service object and the unconverted item according to the unconverted browsing behavior feature.

5. The method according to claim 4, wherein service data comprising the unconverted item comprises Q pieces of target unconverted service data; the Q pieces of target unconverted service data comprising a same unconverted item Pₓ therein; and Q being a positive integer less than or equal to N, and x being a positive integer.

6. The method according to claim 5, wherein the target browsing behavior features of the target service object for the unconverted item comprise Q target browsing behavior features of the target service object for the unconverted item Pₓ;
the determining the ranking factor corresponding to both the target service object and the unconverted item according to the unconverted browsing behavior features comprises:
counting the total feature quantity of the Q target browsing behavior features, and determining the total feature quantity as the total number of outputs of the target service object for the unconverted item Pₓ;
acquiring an earliest record timestamp from record timestamps comprised in the Q target browsing behavior features respectively; and
determining the ranking factor corresponding to both the target service object and the unconverted item Pₓ according to a current timestamp, the total number of outputs and the earliest record timestamp.

7. The method according to claim 5, wherein the ranking, according to the ranking factor, the service data comprising the unconverted item to obtain sequenced service data comprises:
acquiring the total delivery amount of target unconverted service data Rₛ for the service object set, the target unconverted service data Rₛ being any of the Q pieces of target unconverted service data;
determining a real-time delivery conversion rate corresponding to the target unconverted service data Rₛ according to the total delivery amount and the real-time conversion quantity of the service object set for the target unconverted service data Rₛ; and
ranking service data comprising the unconverted item Pₓ according to the ranking factor and the real-time delivery conversion rates corresponding to the Q pieces of target unconverted service data respectively to obtain the sequenced service data.

8. The method according to claim 7, wherein the service data comprising the unconverted item further comprises service data-to-be-delivered comprising the unconverted item Pₓ;
the ranking the service data comprising the unconverted item Pₓ according to the ranking factor and the real-time delivery conversion rates corresponding to the Q pieces of target unconverted service data respectively to obtain the sequenced service data comprises:
acquiring a predicted delivery conversion rate corresponding to the service data-to-be-delivered;
ranking the service data comprising the unconverted item Pₓ in order of magnitude between the real-time delivery conversion rates corresponding to the Q pieces of target unconverted service data respectively and the predicted delivery conversion rate corresponding to the service data-to-be-delivered to obtain initial sequenced service data;
acquiring, from the initial sequenced service data, K pieces of service data with the maximum predicted delivery conversion rate in order; K being a positive integer less than W; W being the total quantity of the Q pieces of target unconverted service data and the service data-to-be-delivered comprising the unconverted item Pₓ;
acquiring desired conversion unit delivery resources, predicted output rates, and predicted conversion rates corresponding to the K pieces of service data; and
ranking the K pieces of service data according to the ranking factor and the desired conversion unit delivery resources, predicted output rates and predicted conversion rates corresponding to the K pieces of service data to obtain the sequenced service data.

9. The method according to claim 8, wherein service data Rₜ is any of the K pieces of service data, t being a positive integer;
the ranking the K pieces of service data according to the ranking factor and the desired conversion unit delivery resources, predicted output rates and predicted conversion rates corresponding to the K pieces of service data to obtain the sequenced service data comprises:
determining an initial delivery unit consumed resource corresponding to the service data Rₜ according to the desired conversion unit delivery resource, predicted output rate and predicted conversion rate corresponding to the service data Rₜ;
performing arithmetic processing on the ranking factor and the initial delivery unit consumed resource corresponding to the target service data Rₜ to obtain a real-time delivery unit consumed resource corresponding to the target service data Rₜ; and
ranking the K pieces of service data in order of size between the K real-time delivery unit consumed resources to obtain the sequenced service data.

10. The method according to claim 9, wherein service data comprising the unconverted item further comprises non-outputted service data; the service output state of the target services object for the non-outputted service data is a non-outputted state;
the ranking the K pieces of service data in order of size between the K real-time delivery unit consumed resources to obtain the sequenced service data comprises:
acquiring the desired conversion unit delivery resource, predicted output rate, and predicted conversion rate corresponding to the non-outputted service data;
determining the initial delivery unit consumed resource corresponding to the non-outputted service data according to the desired conversion unit delivery resource, predicted output rate, and predicted conversion rate corresponding to the non-outputted service data; and
ranking the K pieces of service data and the non-outputted service data in order of size between the initial delivery unit consumed resource corresponding to the non-outputted service data and the K real-time delivery unit consumed resources to obtain the sequenced service data.

11. The method according to claim 1, wherein the method further comprises:
acquiring browsing feedback data of the target service object for the target service data within a target time period; and
performing similar service data delivery processing on the target service object according to the browsing feedback data.

12. The method according to claim 11, wherein the browsing feedback data comprises at least one of: conversion feedback behavior data of the target service object for the target service data, negative feedback behavior data of the target service object for the target service data, and target browse duration of the target service object for the target service data.

13. The method according to claim 11, wherein the browsing feedback data comprises conversion feedback behavior data;
the performing the similar service data delivery processing on the target service object according to the browsing feedback data comprises:
acquiring the converted service data corresponding to the conversion feedback behavior data from the target service data;
acquiring the converted items comprised in the converted service data, and acquiring first similar items of the converted items; and
taking service data to which the first similar items belong as target similar service data, and delivering the target similar service data to the target service object.

14. The method according to claim 11, wherein the browsing feedback data comprises negative feedback behavior data;
the performing the similar service data delivery processing on the target service object according to the browsing feedback data comprises:
acquiring negative feedback service data corresponding to the negative feedback behavior data from the target service data;
acquiring negative feedback items comprised in the negative feedback service data, and acquiring second similar items of the negative feedback items; and
taking service data to which the second similar items belong as target similar service data, and filtering the target similar service data in a service data delivery process for the target service object.

15. The method according to claim 11, wherein the browsing feedback data comprises target browse duration;
the performing the similar service data delivery processing on the target service object according to the browsing feedback data comprises:
acquiring the historical average browse duration of the target service object for the target service data; and
determining the service items comprised in the target service data as potential converted items when the target browse duration is longer than the historical average browse duration, taking service data to which third similar items of the potential converted items belong as target similar service data, and delivering the target similar service data to the target service object.

16. An electronic device, comprising a processor, a memory and a network interface;
the processor being connected with the memory and the network interface, the network interface being configured to provide a network communication function, the memory being configured to store a program code, and the processor being configured to invoke the program code and perform:
acquiring a delivery log corresponding to N pieces of delivered service data, the delivery log comprising service output states and service conversion states of a service object set for the N pieces of delivered service data, N being a positive integer; the service conversion state comprising an unconverted state, the service output state comprising an outputted state;
establishing unconverted browsing behavior features of a target service object for unconverted service data according to the service output states and service conversion states of the service object set for the N pieces of delivered service data, the service output state of the target service object for the unconverted service data being the outputted state and the service conversion state being the unconverted state, the N pieces of delivered service data comprising the unconverted service data, the unconverted service data comprising an unconverted item, and the service object set comprising the target service object;
determining a ranking factor corresponding to both the target service object and the unconverted item according to the unconverted browsing behavior features; and
ranking service data comprising the unconverted item to obtain sequenced service data according to the ranking factor, and selecting target service data from the sequenced service data according to ranking order and delivering the target service data to the target service object.

17. The electronic device according to claim 16, wherein the determining the ranking factor corresponding to both the target service object and an unconverted item according to the unconverted browsing behavior features comprises:
performing service recognition on the unconverted service data to obtain a mapping relationship between the unconverted service data and the unconverted item; the mapping relationship indicating that the unconverted service data comprises the unconverted item;
acquiring an item identifier of the unconverted item, replacing a service identifier of the unconverted service data comprised in the unconverted browsing behavior feature with the item identifier of the unconverted item, and determining the replaced unconverted browsing behavior feature as a target browsing behavior feature of the target service object for the unconverted item; and
determining the ranking factor corresponding to both the target service object and the unconverted item according to the unconverted browsing behavior feature.

18. A non-transitory computer-readable storage medium, the computer-readable storage medium storing a computer program therein, and the computer program being suitable for loading by a processor and performing a service data processing method, comprising:
acquiring a delivery log corresponding to N pieces of delivered service data, the delivery log comprising service output states and service conversion states of a service object set for the N pieces of delivered service data, N being a positive integer; the service conversion state comprising an unconverted state, the service output state comprising an outputted state;
establishing unconverted browsing behavior features of a target service object for unconverted service data according to the service output states and service conversion states of the service object set for the N pieces of delivered service data, the service output state of the target service object for the unconverted service data being the outputted state and the service conversion state being the unconverted state, the N pieces of delivered service data comprising the unconverted service data, the unconverted service data comprising an unconverted item, and the service object set comprising the target service object;
determining a ranking factor corresponding to both the target service object and the unconverted item according to the unconverted browsing behavior features; and
ranking service data comprising the unconverted item to obtain sequenced service data according to the ranking factor, and selecting target service data from the sequenced service data according to ranking order and delivering the target service data to the target service object.

19. The computer-readable storage medium according to claim 18, wherein the delivery log further comprises record timestamps of the service object set for the N pieces of delivered service data respectively; the service object set comprising a service object the N pieces of delivered service data comprising delivered service data G_{b}, the record timestamp of the service object Mᵢ for the delivered service data G_{b} referring to an operation record timestamp of a state change operation of the service object Mᵢ for the delivered service data G_{b}, the state change operation indicating that the service output state of the service object Mᵢ for the delivered service data G_{b} is converted from a non-outputted state to the outputted state; i and b being both a positive integer;
the establishing the unconverted browsing behavior features of the target service object for the unconverted service data according to the service output states and service conversion states of the service object set for the N pieces of delivered service data comprises:
acquiring an object identifier of the service object Mᵢ and a service identifier of the delivered service data G_{b};
determining a data group composed of the object identifier of the service object Mᵢ, the service identifier of the delivered service data G_{b}, the service output state of the service object Mᵢ for the delivered service data G_{b}, the service conversion state of the service object Mᵢ for the delivered service data G_{b}, and the record timestamp of the service object Mᵢ for the delivered service data G_{b} as a browsing behavior feature of the service object Mᵢ for the delivered service data G_{b}; and
determining the unconverted browsing behavior features of the target service object for the unconverted service data from the browsing behavior features of the service object set for the N pieces of delivered service data.

20. The computer-readable storage medium according to claim 19, wherein the determining, from the browsing behavior features of the service object set for the N pieces of delivered service data, the unconverted browsing behavior features of the target service object for the unconverted service data comprises:
determining the browsing behavior feature that the service output state is the outputted state and the service conversion state is the unconverted state as the unconverted browsing behavior feature from the browsing behavior features of the service object set for the N pieces of delivered service data; and
determining a service object corresponding to the object identifier comprised in the unconverted browsing behavior feature as the target service object, and determining, from the unconverted browsing behavior feature comprising the object identifier of the target service object, delivered service data corresponding to the service identifier comprised as the unconverted service data at which the target service object targets, to obtain the unconverted browsing behavior features of the target service object for the unconverted service data.
